(19) United States
(12) Patent Application Publication
(10) Pub. No.: US 2026/0370499 A1
(43) Pub. Date: Nov. 19, 2026

(54) Multi-Dimensional Self-Resolution Meta-System With Emotional Entropy Exchange And Temporal Pattern Compliance Mechanism

(71) Applicant: Saiyi Li, West New York, NJ (US)

(72) Inventor: Saiyi Li, West New York, NJ (US)

(21) Appl. No.: 19/672,621

(22) Filed: May 9, 2026

Related U.S. Application Data
(60) Provisional application No. 63/807,765, filed on May 18, 2025.
(60) Provisional application No. 63/809,284, filed on May 20, 2025.
(60) Provisional application No. 63/812,940, filed on May 28, 2025.
(60) Provisional application No. 63/814,891, filed on May 30, 2025.
(60) Provisional application No. 63/925,551, filed on Nov. 26, 2025.

(51) Int. Cl. H04L 9/00

(52) U.S. Cl. CPC H04L 9/50

(57) ABSTRACT

The invention describes a computer-implemented multi-dimensional meta-system that enhances the ecological value of nodes in various systems by allocating resources efficiently. This system is configured to optimize components through mechanisms such as Temporal Pattern Compliance and Narrative Emotional Entropy Scale, transforming risk management into an exploitable resource for creative problem-solving and strategic innovation. The system is designed to maximize resource efficiency and enhance closed-loop feedback, making nodes traceable, controllable, and reversible. The system comprises modules like Emotional Entropy Exchange Framework, Compliance Framework, and chain-based frameworks that facilitate real-time decision-making for large or cross-domain tasks. Therefore, non-uniform, targeted allocation can be achieved by independently mapping multimodal inputs to their respective features based on data type, thereby enabling compliance through a transition from multi-resource to an extensible, integrated, self-resolutely, operationally relevant, and reconfigurable meta-framework.

### CROSS-REFERENCE TO RELATED APPLICATIONS

This claims the benefit of U.S. Patent Provisional Application No. 63/925,551, filed on Nov. 26, 2025; Provisional Application No. 63/807,765, filed on May 18, 2025; Provisional Application No. 63/809,284, filed on May 20, 2025; Provisional Application No. 63/812,940, filed on May 28, 2025; Provisional Application No. 63/814,891, filed on May 30, 2025, the entirety of which is incorporated herein by reference.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD

The present invention relates to Human-Artificial Intelligence Cognitive Interaction, Multi-Dimensional Computer Science, Self-Learning/Meta-Learning, Federated Learning, Human-Computer Interaction, Ontology and Spatiotemporal Energy Relationship Transition. More particularly, it concerns a proprietary meta-system, architecture, methods of training and inference, Cross-cultural and Communication Systems, Information Security, Spiking Neural Networks, Neuromorphic Computing, Software Engineering, Interdisciplinary Education, Semiconductor Manufacturing,

Cultural Communication, Cyber Security, Medical Interaction, Audit-support, Legal Analysis, Aerospace, Smart City, Digital Twin, Chip Design, Artificial General Intelligence and Business Decision Analysis, and applications thereof in various computational domains.

### BACKGROUND

Traditionally, the meta-system or neural networks' construction may not effectively allocate resources, neglecting reasonable profit sharing and risk assumption, leading to individual components and stakeholders operating independently. This could result in poor system performance, resource waste, and elevated risk exposure. Within the system, there may exist “idle computational power” or “inefficient asset allocation,” failing to maximize resource value. The feedback mechanism between component behavior and output results is not well-established, leading to phenomena such as over-reliance on certain mechanisms for rapid output generation, resulting in short-term gains but long-term negative systemic effects that are not internally corrected. Components may be guided by system node information asymmetry or irrational incentives, causing the system's running behavior to deviate from healthy causal logic loops.

When data is being trained with multiple contradictory poles of positivity and negativity, it may create a high-entropy state. Song models may try reducing entropy through various means; however, controllable entropy is a source of creative emergence. In the exploration of future scientific development, positive emotions may expand cognitive resources and promote creative thinking. If machine learning and deep learning's problem-solving generate positive emotions, it may expand the model's self-awareness into a “conversion from emotional potential to cognitive kinetic energy” which can create more innovative sub-dimensions, forming quantum depth in understanding. However, when collecting data, uncertainty may be artificially created with an uncertainty factor increase. The probability distribution depends on individual differences among spectators, requiring use of a large sample mean. The baseline entropy value is affected by different cultural tolerances for “uncertainty,” which itself introduces additional uncertainty to the base standard of “uncertainty.”

### SUMMARY

This specification describes a computer-implemented independently developed multi-dimensional meta-system and meta-ecosystem integration that operates on one or more computers in one or more locations, invoking one or more mechanisms, including but not limited to Temporal Pattern Compliance, Narrative Emotional Entropy Scale system as a sub-component to establish an triggering and audit-support meta-model; applies one or more as sub-component methods to continue dynamically adjusting the optimization plans, wherein sub-components include but are not limited to Self-Adaptation, Emotional Entropy Principle, Narrative Transportation or Narrative Value Exchange Evaluator; utilizes one or more frameworks to realize real-time optimization decision-making, handles large or cross-domanial tasks while maintaining process controllability and auditability, wherein frameworks include but are not limited to Applicant-defined Emotional Entropy Exchange Framework, Compliance Framework, chain-based Framework or among others. Therefore, non-uniform, targeted allocation can be achieved by independently mapping multimodal inputs to their respective features based on data type, thereby enabling compliance through a transition from multi-resource to a reusable, operationally relevant, and reconfigurable framework.

The system is configured to maximize resource efficiency and enhance closed-loop feedback, enabling nodes that are traceable, controllable, and reversible. The design of the meta-system enables sub-systems to benefit, thereby enhancing the ecological value of each node in the system across all dimensions, developing efficiency, performance, and reusability of sub-systems with universal applicability.

The underlying code and logical flow pattern of Emotional Entropy value exchange method is configured to reflect the core values of each hybrid time action and its outcome, transforming the entire system into a dynamic, innovative, and universality-focused framework that combines generalizability and openness. Module Economics (ME) is configured to standardize different data, experimental results, performance metrics, and actual outputs to a unified module, increasing depth and logical rigor while tracing back events. Temporal Pattern Compliance Mechanisms is configured to ensure resource allocation aligns with target settings. All the systems, neural networks, frameworks, mechanisms, and methods described above can be fine-tuned, customized, or replaced according to specific tasks, industries, and actual situations, along with Applicant-defined domain-specific language (DSL) meta-language.

Implementations of the disclosed technology may achieve one or more technical effects or advantages. The particular benefits described in connection with specific embodiments are illustrative and shall not be construed as limiting the scope of the claims.

Details of representative embodiments are presented in the accompanying figures and in the following description. Additional aspects, variations, and benefits will be apparent from the description, the drawings, and the claims.

For the purposes of this invention and within its ecosystem including but not limited to Applicant-defined Dynamic Balance Adjustment Neural Networks, the terms “autonomous,” “automatically,” “automated,” “self-adaptation,” “self-resolution,” “evolution,” “self-learning,” “self-adaptive,” “self-improve,” “self-developing,” “meta-learning,” “self-expansion,” and “self-modify” are hereby defined under explicit policy as reversible, with a gated approval mechanism, in bounded and supervised refinement, oversight-bounded, human-in-the-loop, chain-of-approval, does not autonomously alter unrestricted parameters, subject to explicit policy constraints, and incorporates customizable real-time feedback loops and offline controlled adaptation only for optional governance, security, and compliance mechanisms. The system also maintains tamper-evident logs and one or more audit mechanisms that include but not limited to real-time detection and automatic alarms, periodic review, and feedback-loops. Each element, including but not limited to metadata, data, components, executions, steps, structure arrangements and rearrangements, state vision, models are associated with identifiers and registered with a DID on the blockchain.

To the best of the applicant's knowledge, the combination of independence, adaptability, and cross-domain integration embodied herein has not been disclosed in prior references. The disclosure thus not only advances the state of the art but also provides a legally distinct and practically verifiable solution meeting statutory requirements under U.S. patent law.

### DESCRIPTION OF THE DRAWINGS

FIG. 1 is a flow diagram of an example process of meta-engine for generating an output from an input.

FIG. 2 is an architecture diagram of an example of the Self-Resolution model.

FIG. 3 is a flow diagram of an example process of the Temporal Pattern Compliance system.

FIG. 4 is an architecture diagram of an example of the system arranged in two different architecture frameworks.

FIG. 5 is a flowchart illustrating a transit process, which is characterized by dynamic self-resolution model.

Like reference numbers and designations in the various drawings indicate like elements. Configuration shown is illustrative.

### DETAILED DESCRIPTION OF THE INVENTION

The design of the meta-system is configured to allocate resources to components and further candidate components, thereby enhancing the ecological value of each node in the system across all dimensions, developing efficiency, performance, and reusability of sub-components with universal applicability. The underlying code and logical flow pattern of Emotional Entropy value exchange model could reflect the core values of each hybrid time action and its outcome, transforming the entire system into a dynamic, innovative, and universality-focused framework that combines generalizability and openness. The system is configured to apply one or more parameters for self-mechanism models as optimization strategies, objectives, or constraints, which are computed based on one or more conditions from Self-Resolution model, comprising calculating one or more conditional thresholds based on the relationship between Resource Utilization Rate, Causal Feedback Function, rewarding behaviors that bring about positive feedback loops, Causal Loop Importance parameters, Systemic Risk Metric parameters, System State, including resource allocation and historical feedback, or other Applicant-defined parameter or functions. Each parameter or function may select or compute from one or more predefined Parameter/Method/Rule Set and Storage (PMRSS) from Narrative Emotional Entropy Scale module.

Traditional methods or parameterized architectures create mechanisms to prevent or mitigate risks with risk focusing strategy; however, the present invention diverges by treating these elements as energy reserves to be harnessed and manipulated for practical use. This meta-system is configured to transform risk management from a protective measure into an exploitable resource, thereby expanding the potential for creative problem-solving and strategic innovation. Complex system data processing may involve generating high entropy in various aspects such as conflict resolution and unfinished issues during mapping, reasoning, output, and feedback processes. The Narrative Emotional Entropy model, based on a framework of information theory and cognitive science, Cognitive Asset Architecture and Foundation, directs the flow of entropy through targeted mechanisms. Through designed models that address uncertainty in system learning development, it may achieve directional movement from anticipation to resolution, high entropy to low entropy. This process might relate to neural reward mechanisms and cognitive dissonance resolution methods for learning and training. The system also incorporates corresponding tools modules for measuring entropic value, making the entire process quantifiable and designed. Throughout the system, these entropic energies are exchanged step by step, reducing uncertainty through revealing, resolving, and completing tasks. This approach allows for early risk prevention or transformation of risks into opportunities for upgrading.

The Narrative Emotional Entropy Scale (NEES) module is configured to quantify risk into tradable, accumulable energy pools allowing independent operation and unified management. It maintains an energy asset balance exchanging through mathematical models that enforce precise entropy exchange to mitigate risks. By identifying risks before they occur, the system may prepare in advance and dynamically guide potential crises to be resolved ahead of time.

In one or more implementations, the system is configured to Multi-dimensional Projection. The system is configured to include processes input data through a series of transitions, mechanisms, and adaptive feedback to produce a verifiable output under Meta Model Mechanism. By provoking a reaction within the target module in Spatial Reaction Pattern Module, the system is configured to trigger energy modules from Temporal Pattern Module. The system is configured to utilize inference methods from Spatial Pattern Topological Transformer Module within Spatial Reaction Pattern Module to render a physical entity that features its own liquid cooling loop and possesses ultra-high bandwidth neural synapses, including but not limited to fluid skeletons. Rebuild Mechanism against dissipative structures and run it in reverse under the protection of Temporal Pattern Compliance Mechanisms. Through multidimensional information, generate a simulation module at the target location that reduces entropy. Rearrange the details within the matter according to the pattern. All components are associated with, including but not limited to an identifier, timestamp or other Applicant-defined watermark and execution of all steps requires authorization validations, including but not limited to DID binding prior to operation and output is associated with Compliance Mechanisms.

In one or more embodiments, the system is configured to receive and list all Emotional Entropy values created within the system, extract feature information based on the data, assign an initial entropy value to each uncertainty, and provide the logical chain of each step from each multimodal input to audit. The system's operation can be described as a series of functions applied to this dataset. The system is configured to estimate primary nodes of the system, such as Spatial Reaction Pattern Module (SRPM), Spatial Domain Module (SDM), Spatial Pattern Topological Transformer Module (SPTTM), and Temporal Pattern Module (TPM); schedule energy calculations and exchanges within each node. Wherein the system may calculate a conditional relationship between all nodes' Emotional Entropy return rate (which returns the corresponding system state) and new increasing rate (which increases the corresponding system state). At each time point, if an event value decreases due to events or increases due to new information, the node value can be represented as a relationship of Module Economics ratio or parameters, Self-Resolution indicator, and Narrative Emotional Entropy value at each step. The system is configured to plot Emotional Entropy patterns graph with nonlinear functions or linear functions, and check if the patterns follow the estimated pattern and computes the Module Economics (ME) ratio with each round and the previous round. Based on the difference value, optimization target, and policy or rule, it determines whether a model-update condition is satisfied. If the performance does not satisfy a threshold metric, the system may re-input the computed result into the processing module for subsequent rounds of computing as an optimization step. The system dynamically decides whether to rearrange modules or generate one or more further candidate modules, execute rollback or model-update.

In one or more embodiments, the system is configured to be applied in a Cross-Domain Emergency Coordination system under the Emotional Entropy Exchange framework. An autonomous vehicle may include one or more independent subsystems from different suppliers, including but not limited to a camera-based perception module, radar-based ranging module, braking controller, steering controller, and suspension controller. Each subsystem is configured to operate with its own native data format, clock domain, and communication protocol. The central coordination logic acts as the unified entity that manages the overall common representation of these independent subsystems. When emergency situations require synchronized or united operations (including but not limited to when a pedestrian is detected), the camera is configured to detect a pedestrian and generate a first input in a structured video-object format. The radar may independently compute a time-to-collision value and generate a second input in a sparse point-cloud format. The central coordination logic receives both inputs, aligns them via an internal cross-clock-domain synchronizer, and generates a single standardized emergency common indicium. This indicium comprises one or more timing reference markers, module identifier list (including but not limited to braking, steering, suspension), operation command codes, and priority fields. The indicium is broadcast over a dedicated common bus to all functional modules. Each module's local indicator parser interprets the indicium according to a pre-provisioned common interpretation rule stored in its local memory. Upon receipt, the braking controller may initiate maximum braking force, the steering controller executes an evasive trajectory, and the suspension controller stiffens the outer dampers-all within the same window.

In some further embodiments, the system is configured to be applied in an Industrial Robot with Emotional Entropy Exchange framework. A production line comprises a multi-axis articulated robot from one or more vendors providing multimodal input including but not limited to vision inspection station, and a variable-speed conveyor. Each device runs its own proprietary controller with its own communication protocol. The central coordination logic includes a protocol adaptation module that receives state inputs from all four devices in their respective native protocols and resolves them into a common intermediate representation. During a production run, the central coordination logic generates a rhythmic common indicium that specifies the current production beat, the expected position of each device within that beat, and the next-beat advance notice. The indicium is transmitted via a publish-subscribe mechanism over a dedicated common bus. Each vendor device is configured to be retrofitted with an indicium parser that interprets the indicium according to a locally stored common interpretation rule. When a product changeover is required, an operator may select a new template from the indicium template library. The central coordination logic may issue a changeover indicium containing a new beat rate, new device position parameters, and a new priority ordering. All devices simultaneously adopt the new production rhythm without individual reprogramming.

In other implementations, the system is configured to be applied in a lockstep united entity and cooperative power management system with Emotional Entropy Exchange framework. A System-on-Chip includes one or more heterogeneous processing cores. Each core operates in its own independent clock domain and voltage/frequency scaling regime. The central coordination logic may be implemented as a hardware coordination module on the security operation center. During a distributed inference workload, all modules are assigned different shards of the same neural network layer. The central coordination logic receives task-completion state inputs from each core and, upon determining that all cores have completed their respective shards, generates a barrier common indicium where different components can operate at their own pace. The indicium contains a clock-gating fence marker, a next-shard assignment, and an aggregated voltage/frequency scaling instruction. The Digital Signal Processor receives a separate indicium portion designating it as the aggregator for the next layer. During idle intervals, the central coordination logic receives power-state inputs from all cores and generates a unified power-management indicium that simultaneously scales all cores to a coordinated voltage/frequency point, preventing power rail oscillations that would occur if each core independently changed its own power state.

Alternatively, the system is configured to be applied in a distributed energy network with Emotional Entropy Exchange framework. A regional energy network may comprise one or more photovoltaic inverters, battery energy storage cabinets, and electric vehicle charging stations. These devices are owned by different entities, connected through different communication protocols, and geographically distributed across multiple substation zones. The central coordination logic maybe deployed as a cloud-based service with edge aggregation nodes at each substation. The system is configured to receive input comprising: a grid frequency measurement from a Phasor Measurement module; a real-time electricity price signal from a market operator; and aggregated state-of-charge and generation-capacity data from the edge nodes. Based on these inputs, the central coordination logic generates a dispatch indicium allowing with an uneven or asynchronous rhythm for applied component that specifies including but not limited to target aggregate power adjustment amount, per-zone allocation vector, and execution timestamp synchronized to the grid's absolute time reference. The indicium is transmitted to the edge nodes, which locally broadcast it to their respective devices. Each inverter, upon receiving and interpreting the indicium via its installed indicium parser, simultaneously curtails its output. Each storage cabinet simultaneously discharges at its allocated rate. Each charging station simultaneously pauses or reduces its charging load. The entire fleet of devices responds as one dispatchable entity.

In certain variations, the system is configured to be applied in a digital twin and multi-source Spatiotemporal-Energy alignment system with Emotional Entropy Exchange framework. A digital twin environment ingests real-time data from a camera, a sensor, an Inertial Measurement module, and an Ultra-Wideband positioning system. Each sensor outputs data with its own independent timestamping and value mechanism, coordinate reference frame, and data structure. The central coordination logic first generates a Spatiotemporal-Energy anchor indicium. This anchor indicium establishes: a corrected absolute timestamp derived from a global time reference, a unified coordinate system origin with transformation parameters for each sensor's native frame, and a temporal interpolation window. Each sensor's data is then retroactively aligned to the anchor indicium before fusion. The aligned data may be fused into a single coherent world-state representation.

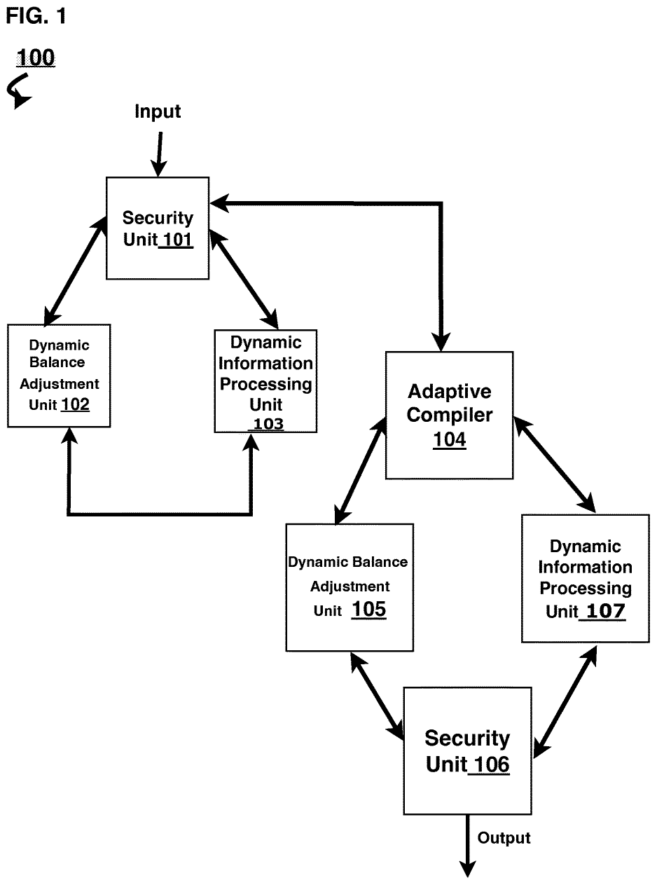

FIG. 1 is a flow diagram of an example meta-engine for the Meta-system. The Meta-system comprises at least one or more: Dynamic Balance Adjustment Unit (DBAU) 103, Dynamic Information Processing Unit (DIPU) 102, and Security Unit (SU) 101, which sends trigger signals, generates intermediate representations with reversible Self-Resolution models.

The system is designed with a modular architecture, incorporating one or more modules that mix training data patterns from various rules. The flexible modules may access real-time external memory systems, enforcing the system to achieve cross-session state preservation and real-time updates in one or more embodiments, rather than relying more on static weights. In one or more alternative embodiments, the system adopts a hybrid topology combining hierarchical polymorphic topologies with connections. This hybrid structure offers depth efficiency, including but not limited to tree-like structures, while incorporating typical cross module information sharing characteristics of mesh structures. The configuration may balance representational richness and computational scalability, providing enhanced parallelism and higher throughput, particularly in environments where precision and latency constraints are critical.

The system is configured to generate and arrange corresponding independent operator modules for each respective feature's spatiotemporal energy relationships from a multimodal comprising one or more respective input features to one or more corresponding independent operator modules at each of a plurality of input features in a respective proprietary polymorphic topological configuration based on different feature spatiotemporal energy relationships of the multimodal input, achieving a non-uniform, targeted arrangement of the corresponding independent computational components based on data type.

SU 101 improves data security via encryption and decentralized storage, while Real-Time Evaluation Mechanism provides computations suitable for edge computing by real-time interactive visualization. These three main components of the system remain as an Multi-Dimensional Self-Resolution feedback loop that generates further candidate components or rollback if the predefined performance does not satisfy a threshold metric. The DIPU 102 returns new state information, which the DBAU 103 uses to further adjust strategy and re-issue instructions. The system is configured to initiate in SU 101 to detect the security of the environment. Only when a comprehensive ratio, including but not limited to secure environment, transformation environment, learning speed, cost of collection, cost of storage, cost of computation, cost of mental health, and value insight, exceeds a certain numerical threshold, will it trigger the global system.

In one or more embodiments, the system is configured to apply Meta-Core Engine comprising one or more metarules rules, which define the system's ultimate objectives and value judgments, including but not limited to Emotional Entropy Exchange Principle. The Meta-Core Engine is configured to be implemented in hybrid hardware-software form to control Self-Resolution vehicles, manage cargo, and coordinate docking at orbital stations. The system is configured to adapt in real-time to traffic conditions, planetary weather, and route changes. The DBAU 102, DIPU 103, and SU 101 are configured to be applied into the system further forming the fourth main component Adaptive Compiler. The revertible Adaptive Compiler (AC) 104, DBAU 105, DIPU 107, and SU 106 as Meta-Core Engine are configured to dynamically trigger future models for analyzing data to generate optimized strategies or instructions for a planetary surface transportation system. The outputs from SU 101, DIPU 103, and DBAU 102 are processed together within the AC 104 to dynamically adapt the strategies based on real-time data. AC 104 itself comprises one or more DBAU, DIPU, and SU.

In some embodiments, the system further comprises a gating function that controls whether uploaded data is accepted for on-chain recording as Intelligent Highways platform control system. DBAU 102 is configured to make decisions, judgments, or select the optimal pathway based on the metarules and refined features; modify the system as monitor module with mechanisms. The system is configured to be arranged in a re-adjustable proprietary polymorphic topological configuration (PTC), dynamically changing, or maintaining the configuration structure based on the signal from the monitor module, and predefined parameters. Each arrangement, readjustment, or further candidate component generation are constituting a change event that associates with identifiers, and uploads to a tamper-evident append-only ledger. The system is configured to modify and schedule one or more execution graphs for each of the multimodal input features at a time control, publish one or more versioned plans with transactional rollback if the performance does not satisfy a threshold metric, explore, generate, process, and evaluate key patterns, relevant threshold values, and uncertainties, use the key patterns, relevant threshold values, and uncertainties as constraints for nodes linking, logical and structural superpositions to trace the inference chains to align with target intentions of the multimodal input; maintain one or more versioned inference states for further verification, wherein inference applies logic-looping, tracing, foot-printing reasoning, vector space geometry, probabilistic, symbolic, and self-learning under feedback loops to align with target intentions of the multimodal input, and maintain versioned inference states for further verification, trigger rollback to a prior version upon detected policy or constraint violation.

In one or more embodiments, AC 104 is configured to be applied in the Crisis Management and Governance framework for Agentic AI Governance, Policy Simulators, and Cyber-Resilience Platforms. Where data sharing proceeds from Security Operations Center, Self-Resolution AI Agents for Crisis Response to an Agent-Based Modeling software which is used for crisis impact analysis, AC may dynamically apply, including but not limited to Starlink, Mesh Networking, Digital Twin Reconstruction. Each module of the system may be implemented in a custom hardware circuit configured to perform its designated tasks, in a virtualized execution environment, including virtual machines, containers, or cloud-based computational resources, in a combination of hardware, software, firmware, and virtualized resources. At least some modules may be implemented in custom hardware, while others are implemented in virtualized or software-based environments, and the system dynamically manages all modules according to its mechanisms.

In one or more implementations, a portable version of the system may be implemented on a mobile edge device, where each module is deployed as a virtual container or as a custom hardware chip. The system may dynamically select which modules are activated based on the system state, and modules can be generated, removed, or reconfigured in hybrid-time. The system may also integrate distributed computational nodes communicating over a network to extend processing capacity based on Emotional Entropy. The system maintains global system state, dynamically assigning modules to available resources, and allowing modules to migrate between physical and virtual platforms. Each computational module may be implemented in custom hardware circuits, including ASICs, FPGAs, neuromorphic chips, or future space-qualified computational devices to manage spacecraft navigation or onboard control.

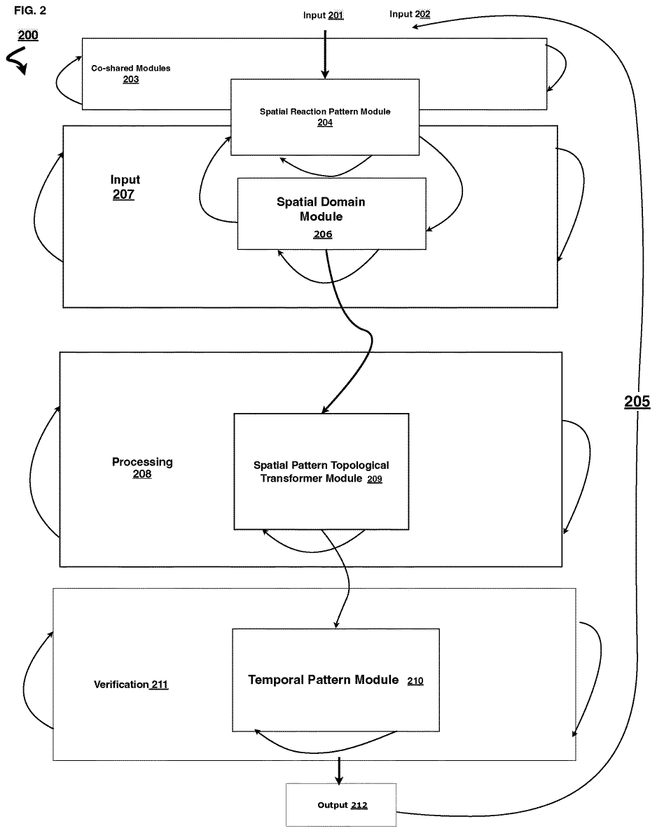

FIG. 2 is an architecture diagram of an example of the system by applying 3×3 Logic Framework. The architecture of the system comprises at least one or more components arranged as at least four modules: a Spatial Reaction Pattern Module (SRPM) 204, a Spatial Domain Module (SDM) 206, a Spatial Pattern Topological Transformer Module (SPTTM) 209 and a Temporal Pattern Module (TPM) 210. The system comprises a dynamically balanced, multi-dimensional, and Self-Resolution model architecture, characterized by a Polymorphic Topological Configuration (PTC). This PTC system incorporates DBAU, which are integrated through a non-linear, self-organized process. The configuration is not limited to networks, blocks, modules, Quantum-like Structure, layers, DAG, mesh, tree, hybrid, or Applicant-defined configuration. In some deployments, SDM may also replace with all-in-one AC, comprising SU, DBAU, DIPU as meta-core engine.

In one or more embodiments, the system is configured to trigger the initial operation by one or more computational request; verify the computational requests and execute further operation only after verified event detected; receive verified multimodal input in multi-forms; process and determine one or more value of each state at every step with one or more predefined exchanging frameworks, methods or mechanisms; generate one or more updated value representation of every step; use one or more updated value representation to constantly compute one or more updated control ratio representation through one or more predefined transformation methods; compare the control ratio representation and one or more predefined thresholds or conditions based on task; execute further operation based on one or more control ratio representation conditions; generate output only if the control ratio representation conditions satisfy one or more predefined condition thresholds based on the task.

Through independently developed ME framework, different data, experimental results, performance metrics, actual outputs are configured to be standardized and parameterized to a unified unit, transforming entropy into a flowing transaction pool, increasing the depth and logical rigor of system output, and tracing back the chain of events. The Emotional Entropy value mechanism is configured to ensure that resources are not scattered, and the system's interactions and mapping align with its original target settings.

In one or more further implementations, the system is configured to apply ME and dynamically select models to compute an updated trigger threshold representation at each revision step. Such model may include but not limited to Incremental Return on Investment (IRI), Retention Churn (IC), Lifetime Value (LTV), Customer Acquisition Cost (CTAC), Marginal Cost (MC), Network Effect (NEW), Year Over Year (YOY), Return on Investment Ratios (ROI), Operating Leverage (OL), Marginal Contribution (MGC), Gross Profit Multiple (GPM) or other Applicant-defined model and strategies. This method is used to monitor the system-wide energy distribution, preventing uneven energy distribution or benefit inequality in a given node. The system is configured to require under self-application, and check for the logical chain, scheduling fairness policy bypassing root privilege abusing. A node that imposes constraints without receiving corresponding benefits may break system symmetry; therefore, the constraint and benefit must apply to all nodes under Compliance Mechanisms with Module Economics.

In particular, as time progresses, at each time point “t”, the value of an event may decrease due to events or increase due to new information, then at time t, the Narrative Emotional Entropy value. The system may be triggering further model, characterized in that the step is executed contingent upon satisfying a predefined threshold condition, said threshold condition comprises including but not limited to hybrid time, trigger action, and trigger predefined threshold. The system may apply Self-Resolution models, rules, and mechanism followed by including but not limited to dynamic gating transition function. The system may compute the updated representation according to one or more functions that computes parameter from the Emotional Entropy Principle.

In other implementations, the training process is configured to employ optimization objectives including but not limited to system Emotional Entropy prediction error, model Emotional Entropy complexity, robustness, Emotional Entropy penalty terms, Emotional Entropy locality, Self-Resolution rate, and Emotional Entropy auditing functions. The prediction error is configured to measure consistency between model outputs and ground truths, while complexity terms constrain model parameter norms. Parameters are configured to iteratively adjusted to gradually reduce the objective function to predefined thresholds.

The system may include one or more training datasets, including but not limited to raw data, compressed rate, fact rate, and robust functions. These datasets is configured to measure differences between Emotional Entropy values (including but not limited to mean squared error or cross-entropy) and impose parameter constraints (including but not limited to multiple functions or their variants). Parameter coefficient is configured to be dynamically adjusted within task-related predefined ranges based on validation set performance. Specifically, an optimizer may use adaptive moment estimation methods with learning rates applying exponential decay strategies.

Wherein the features of multimodal data input have multi-dimensional features, wherein the Self-Resolution model can be computing one or more output. The final output is an aggregate respective task-specific matrix including but not limited to Time Pulse pattern representations for the input pattern, dynamic visualization, or any other predefined multimodal form. Initialize the state representation based on the specific task and initial value.

In one or more further implementations, the system is configured to enable the model under the Experiential Structure Framework to adjust to current computation environmental noise or special variables at each step, repeatedly refining its high-precision control through timestamped dynamic indexing. The system is configured to continuously evolve as not only looks at immediate return value, but also calculates the total return value. When the system discovers that the real-time feedback is greatly different from what was expected, the model's correction is not just for the previous step's decision, but rather to pave the way for all future steps. Even if a single node loses some value the state has high value in the future, so this step's logic chain allows for attempts and strings together countless discrete trial points into one directional evolutionary line. The system one or more parameters for Experiential Structure Framework as optimization strategy, objectives or constraints are configured to be applied and computed based on one or more conditions from; system's current situation Emotional Entropy value, model's decision based on the table, new situation Emotional Entropy value that the world pushes the model into after it tries something out, the action that the model is expected to take in that new situation, the expected return value of taking action in state, the immediate reward feedback from reality, the discounting of future Emotional Entropy values. The system needs to calculate not just whether this step is correct, but also whether it will bring the model into a more favorable state for deriving a predefined scenario (including but not limited to the value of the next state). The model is configured to be designed for real-time updates, because it gazes at the next step, causes the system's Self-Resolution model to continuously make forward-looking adjustments.

In one or more further embodiments, the system is configured to apply Experiential Structure Framework for accounting system. Through checking Emotional Entropy's fluidity map, the system automatically assigns different outputs and inputs to energy channels based on their intended use. All actual nodes are unified into a meta-system through integration of time, space, and energy factors. The system may self-adaptatively classify different transactions according to specific usage scenarios, financial flow patterns, and final destinations. The system may provide visualization dynamic graphs and timestamped chain links, smart contracts, and certificates to facilitate data classification.

The Compliance framework may dynamically be applied in all the component headers or payloads or referenced out-of-band in the outputs, providing real-time feedback on compliance status. In certain embodiments, the system employs Compliance Mechanism when outputs may be blocked upon compliance failure; outputs may be encrypted upon compliance success with annotations indicating compliance status; execution may be blocked upon attestation failure; usage attestations may be generated per batch and bound to the DID, with transactional rollback performed upon an error condition including rule or policy violations. This embodiment ensures that only authorized entities may invoke system functionality.

The Temporal Pattern Compliance framework is configured to integrate scattered functions into a collaborative platform or integrated framework, enabling high-contrast core diagrams to solidify structures, eliminate redundant data transmission paths, and supplement depth, as well as trigger modules for long-distance interactions. In some embodiments, an interstellar fleet control application, modules controlling navigation or cargo management may be instantaneously migrated including but not limited to vehicles, spacecraft, orbital platforms, or planetary hubs to respond to changing operational conditions, simulating a transition moving hardware. The system is configured to apply Temporal Pattern Compliance framework to compute a value as alignment ultimate state for initialization by Review Committee Mode. Wherein the framework may dynamically select parameters from Task Alignment Index, Self-Resolution Index, Stress Testing, Pioneering Milestones, or other parameters from Self-Resolution model of Narrative Emotional Entropy, Temporal Pattern Compliance Mechanisms ecosystem, Critical Situation Response Methods, Review Committee Methods, including but not limited to rate of Dynamic Frequency, Amplitude, Fatigue, Openness, Potential Force, Relationship, Trust Index, Target state of Ultimate order value, or domain-specific Energy (including but not limited to system behavior, performance metrics or other parameters) from PMRSS. All parameters above could be set as domain-specific requirements to dynamically adjust various parameters within the system, and may be obtained by applying a mapping function to input data. The mapping function may be any suitable function, including but not limited to a linear transformation, a nonlinear transformation, a polynomial function, a power function, an exponential function, a neural network model, a kernel function, or any combination thereof. In different implementations, different computation techniques may be employed.

In one or more embodiments, the system is applied in a legal-support, under Self-Resolution reasoning cycles involving input, inference, and real-time logical verification, along with one or more Feedback-Loops frameworks. Raw input data from various legal documents is processed through Information Extraction, Relationship Inference, and Logical Generation steps to extract relevant features, infer relationships, and generate logical conclusions or predictions about the outcome of the legal case. The Feedback-Loops help to identify risks at each stage of processing and for legal auditing purposes. By continuously refining the data, the system can achieve more accurate predictions with each iteration. The system may iteratively refine data through multiple cycles, achieving more accurate predictions with each iteration, while Feedback-Loops help correct biases, allowing the system to adapt to new data and refine its approach over time. This system may continuously compare system outputs with target objectives and generating corrective actions when deviations are detected. For example, in a surgical robotic system performing microsurgery, the Feedback Loop dynamically adjusts force and trajectory based on real-time data.

These processes may extend both forward and backward, providing comprehensive coverage of the inference state space. Each unit, block or module is embedded with a watermark including but not limited to a model identifier, a generation timestamp DID, and cryptographically signed. The framework enforces scalability and privacy preservation with read-only security status API for dynamic auditing. The federated training may support global epidemiological surveillance, where data locally while contributing aggregated statistics to a central model.

DIPU is configured to use optimization rules or classifiers to make selections; generate content based on decision outcomes; enforce output to specific formats or standards; upon system output, it may collect user feedback or environmental changes (as new inputs) and re-enter the reasoning module for recursive optimization. Meanwhile, the output result is used for metamodel fine-tuning with stability maintained for the metamodel itself.

The system and method are executed on one or more processors, including at least one accelerator device. The process window is adaptively selected based on, including but not limited to, observational criteria or determinants and configuration stably meets the performance metrics under the constraint parameters of Functionality, Reliability, Cost, Yield. After received the input, the system generates structural patterns or features based on Structural Generative Factors; improves all nodes/blocks to be extended with dynamically information propagation strategies, including but not limited to graph messages passing, hierarchical messages passing, geometry-based messages passing, relational data messages passing or Applicant-defined dynamic strategies. The system may provide transactional rollback to a prior version upon detection of a rule, strategy, policy, or constraint violation, wherein all executions are rejected absent valid authorization without changing the core system structure.

In one or more embodiments, the system is configured to recognize and identify where uncertainty would be created within the emotional legacy synthesis system, quantify and assign a value to each feature based on its task, including but not limited to uncertainty, compute the emotional entropy which should ideally have an Exchange Period or the timeframe within which the audience expects it to be resolved (for example, small exchanges might be resolved within the same dataset while a larger one could span across the entire dataset), and plan and schedule events for exchange within the nodes. Subsequently, an Self-Resolution loop is used to build the emotional legacy synthesis framework based on multi-modal memory trajectories, which helps to digitize interpersonal biorhythm. Multi-modal data frequency, including but not limited to collective consciousness electroencephalogram spectrum, are collected to construct Neuro-Feedback Shared Empathy Spaces. This may involve including but not limited to large language models and memory extraction, soft electronic and tactile sensing, biofeedback and generative art, neural synchronization, or virtual reality.

Through the multi-dimensional and multi-modal pattern including but not limited to conversion of time, space, and heat, it provides task-defined visualization outputs. The system is configured to enforce that exchanges are gradually reduced but avoids paying off all Emotional Entropy exchanges at once, which would make the system training seem uneventful. Additionally, the system manages multiple simultaneous exchanges by assigning them priorities and interdependencies.

In one or more embodiments, the system is configured to The system is configured to enforce compliance based on access control and deterministic buffering. Its core logic includes, but is not limited to, absolute isolation from external environments and data, and internal self-resolution energy storage. The system is configured to be activated only after meeting specific threshold values based on long-term stability metrics, robustness against abnormal scenarios, and time-validated indicators. SU's hardware-level access Brake Gateway is configured to dynamically execute a compliance strategy in real-time. The system is configured to self-adaptatively locking down any unfamiliar data packets to ensure the system's core remains uncontaminated. Any unverified bitstream is configured to be prohibited from accessing memory. DIPU's Immutable Kernel is configured to kernel serves as a constraint and aligns inference parameters. DIPU is configured to operate in a compliance protected environment, receiving only fully compliant instructions for execution. DABU's Determinism Scheduler is configured to monitor the system's workload and compute saturation. It strategically releases high-quality computational results based on system capacity. Compliance Mechanism's asynchronous update method is configured to self-adaptatively intercept all high-entropy actions and converts them into controlled states. The buffer is configured to feature an buffer autonomy system for emotional entropy exchange. Co-share layer such as Spatial Reaction Pattern Module is configured to handle data exchange and storage, preventing external pressures from directly impacting the buffer layer. The system is configured to internally determine result output timing based on its own Compliance Mechanism.

In one or more further implementations, the system is configured to apply Temporal Pattern Compliance Mechanisms in a multi-dimensional Management and Trading of Mineral Reserves manifestation system. Temporal Pattern Compliance Mechanisms including but not limited to Spatiotemporal Energy Relationship checksums, which verify the conservation of mass and energy at the target location, checking for spatial collapse or exothermic reactions; DEP (Data Execution Prevention) module assists in directly converting various types of data into instructions; Anti-Address Space Layout Randomization (Anti-ASLR) and Encryption System is configured to unify the handshake protocol between both sides, fixing interaction addresses to a specific destination; Alloc-Overwrite-Keep-Running (AOKR) destination generation system dynamically is configured to allocate space within the co-shared Spatial Reaction Pattern Module's target-land Engine. The system comprises one or more computers and one or more storage devices storing instructions that when executed by the one or more computers cause the one or more computers to implement to transit a multimodal input comprising one or more respective input features to one or more corresponding independent computational component with at least three dynamic self-Resolution model with Emotional Entropy Scale at each of a plurality of input features in an input Spatiotemporal Energy Relationship and to generate an aggregate respective task-specific output into a desired pattern in a desired form through a designed endpoint of each of the plurality of input features in the input Spatiotemporal Energy Relationship, achieving a comprehensive resilience compliance functionality through scaling Emotional Entropy Value, targeted independently planning, exchanging, allocation and resolution output for each feature within the same consistency in associations between various features and Spatiotemporal Energy based on data type.

In certain variations, the system includes but not limited to one or more comparison module (including but not limited to DBAU) is configured to receive one or more parameters; one or more computation module (including but not limited to DIPU) is configured to generate trigger signals based on predefined judgment logic, comparing parameters against set thresholds; one or more execution module (including but not limited to SU) is configured to respond to trigger signals by executing protective actions. The system offers flexibility in designing the transition function to suit specific task requirements. For instance, it may employ separable convolutions, dynamic, gated or a fully connected network having a single rectified-linear activation function between two linear transformations, applied position-wise using quantum gates or operations, applied on a per-element basis including but not limited to individually to each row of the computed representation.

In one or more embodiments, this system is applied for Self-Resolution model structured infrastructure system and platform. Wherein each module is configured to: execute one or more methods/rules/logic strategies for processing the input data; modify execution graph at hybrid-time under an acyclic graph, determine whether to generate a candidate module or execute rollback based on the combination result of one or more factors including but not limited to data information, model, policy, real-time evaluation; perform bounded parameter adaptation to form an updated module; inference, decision-making and scheduling; drive output as upgraded next-generation parameters to improve the overall efficiency and effectiveness of the operations within the system; provide one or more read-only, security status application programming interfaces (APIs) for auditing, allowing for real-time validation of its compliance without interrupting system operation.

The system applies one or more orchestration or cross-platform information processing frameworks to improve system's ecosystem resilience, where units interact through one or more mechanisms including but not limited to Trust-Based. The framework may allow one or more functionally differentiated systems to achieve coordination through mechanisms and enables multiple implementations, including but not limited to supervised learning, unsupervised learning, reinforcement learning models, deep learning model, generative adversarial networks, natural language processing, recommendation system, natural restoration, time series analysis, federated learning, artificial augmentation models, while maintaining adaptability across diverse ecosystem conditions at hybrid-time.

In some further embodiments, the system is configured to: receive data and the trigger signal from Compliance Mechanism; assign an initial Emotional Entropy value to each node, list all the Emotional Entropy value which created within the system; extract feature information based on the data; trigger meta-model of the system to generate at least at least three dynamic self-developing modules comprising Spatial Domain Module, Spatial Pattern Topological Transformer Module, and Temporal Pattern Module; schedule energy calculations and exchanges within each node; plot one or more Emotional Entropy graph, check if it follows the estimated patterns; compute the ratio with each step and the previous step at time, determines whether a model-update condition is satisfied based on the difference value, optimization target, and policy or rule, reinputs the computed result into the processing unit for subsequent round of computing as an optimization step, dynamically decides whether to rearrange modules or generate one or more further candidate modules, or execute rollback when the performance does not satisfy a threshold metric; transit a multimodal input comprising one or more respective input features to one or more corresponding independent computational components with at least three dynamic self-Resolution modules with Emotional Entropy Scale at each of a plurality of input features in an input Spatiotemporal Energy Relationship and to generate an aggregate respective task-specific output into a desired pattern in a desired form through a designed endpoint of each of the plurality of input features in the input Spatiotemporal Energy Relationship.

The system is configured to invoke Temporal Pattern Compliance Mechanisms, Dynamic Balance Adjustment Mechanism and Real-Time Evaluation Mechanism that introduce real-time dynamic Closed-Loop Alignment control and multi-level feedback mechanisms. These are configured to allow the system to dynamically adjust specific parameters under guidance from the DIPU, DBAU, AC, and SU, while adapting behavior and target states in response to external environment changes. The Temporal Pattern Compliance Mechanisms is configured to improve compliance resource allocation and optimization under varying conditions and enforce reversible self-adaptive activation of specific operations based on real-time events.

The multiple Emotional Entropy convention numbers facilitate connections between different systems, components, and existing standards, resolving interface standardization issues and risks that cannot be predicted in advance, a common pain point within industries. This may allow systems and users from diverse backgrounds to collaborate on a single platform. In another embodiment, a Temporal Pattern Compliance Mechanism is configured to be employed to enforce that only authorized models are executed and used in a Self-Resolution high-speed data transfer, low-latency communication, real-time module synchronization or asynchronous abstract computational framework and advanced modular system. Specifically, decentralized identifier (DID) authorization is recorded on a blockchain ledger and expires after a predetermined validity period, dynamically renewed prior to expiration. The DID authorization requires multi-party signatures, and a corresponding signature chain is recorded on the blockchain ledger for auditing purposes. The Temporal Pattern Compliance Mechanism may also include but not limited to Fetal Brain Metabolic Crossover module which dynamically generates further components. The Fetal Brain Metabolic Crossover module may include but not limited to: Experts-and-Humans Loop Mechanism, Energy Dissipation Limitation Alarms Mechanism, Stress Simulation Mechanism, Value Review Mechanism, Fetal signal Mechanism, Ethical Baseline Mechanism, or other Applicant-defined mechanisms.

In one or more embodiment, this system is applied for a neural network system for Collecting and Trading of Antiques and Artifacts platform. The neural network system is configured to select different mechanisms to enforce Multi-Dimensional Self-Resolution ability including but not limited to: Energy Dissipation Limitation Alarms Mechanism for applying Placental clock time mechanism and Narrative Transportation system with real-time feedback and expert-human-in-loop, enforcing real-world connections during training with limited loop cycles, allowing for real-time detection, periodic review, and feedback-loops; Value Review Mechanism for applying Narrative Emotional Entropy Exchange Evaluator under Fetal signal mechanisms and Review Committee Mode for periodic value reviews; Ethical Baseline Mechanism for apply SMLS meta-language and Self-Resolution model serving as the core of ethics, preventing tampering; Creative Orientation Mechanism for applying Output module reverse-guidance Meta-model and SU-initiated Value Alignment mechanisms. Wherein each computational module of the system may be implemented in custom hardware circuits, including but not limited to ASICs, FPGAs, neuromorphic chips, or any later-developed hardware devices not yet conceived. Each computational module of the system may be implemented in software, firmware, virtual machines, containers, or cloud-based computational resources. Each computational module may be implemented in a combination of hardware, software, firmware, virtualized resources, or later-developed computational technologies. The system may be deployed on including but not limited to mobile devices, portable computing platforms, edge computing nodes, or any later-developed distributed computational platforms. The mechanisms may dynamically generate, remove, or reconfigure computational modules in real-time, adapting to changing inputs, system states, or computational environments, including later-developed implementations.

In one or more embodiments, the Temporal Pattern Compliance Mechanism with Dual-Track Governance Structure and Review Committee Mode framework comprises multiple expert modules and human reviewers that perform real-time ratings of data. This traceability may extend across multiple ledgers. The system is configured to enforce the integrity and reliability of system output, which is utilized in a financial risk management system. Upon activation of the Full-Chain Accountability Loop and Responsibility Mechanism within the Compliance Mechanism, the DID is bound to a model or state version identifier, and execution is rejected absent a valid DID authorization, with rejected attempts logged. Additionally, execution is suspended upon DID revocation. A requesting entity must first bind a DID to its request and present a cryptographically verifiable authorization token. This token is validated against plan metadata, including version identifiers and tamper-evident logs. If the token is invalid, expired, or absent, execution of methods is rejected by the system. Furthermore, usage attestation may include a model version identifier, a license scope, and be cryptographically signed to improve the authenticity of the attestation. Access logging includes a usage timestamp, a user identifier, and is stored on a tamper-evident ledger to provide an auditable record of all accesses. Moreover, provenance tags include lineage information and a cryptographic hash to improve the authenticity of the data.

In one or more embodiments, the system is applied for a Theater of the Mind and Consciousness Ecology Installation under Creative Orientation Mechanism. The Collective Affective compliance enforced interaction protocol system utilizes affective computing to convert Emotional Entropy into energy forms such as thermal or light energy, driving the Emotional Entropy Lab. This drives the Sensory Substitution Expo, and the Spatial Reaction Pattern Module collects heart rate, brain waves, skin conductance, and eye-tracking patterns to drive the future science interaction exhibition space Synaptic Plasticity and Bio-Feedback Interaction. All this energy value is anchored through Creative Orientation Mechanism, which includes but not limited to Self-Resolution model and Security Module that comprises Value Alignment mechanisms initiated by SU. The time in this anchor mechanism is a constant and anchor value, while the input selection values serve as indicators of choice and creative indicators. Through this method, the system is configured to stabilize pattern transformations and protect data security.

In one or more embodiments, the Temporal Pattern Compliance Mechanisms are configured to enforce the system and its components to compliance target states, aligning with specific problem requirements by Narrative Emotional Entropy Scale (NEES). A fleet of Self-Resolution cargo spacecraft equipped with the Meta-System, where each computational module is deployed as a virtualized software container or as custom space-qualified hardware. The system is configured to monitor fleet state, dynamically activating modules for navigation, collision avoidance, or cargo management.

Modules are configured to migrate between spacecraft or orbital platforms as needed to optimize route efficiency along interstellar commercial lanes. Temporal Pattern Compliance Mechanisms are configured to enhance the effectiveness of the model's rules, allowing for reversible self-adaptation, meta-learning, and self-adjustment, introducing multiple entropy adjustment factors or simultaneous consideration of various entropy mechanisms, leading to optimal narrative entropy model performance or convergence. The system's multi-modeled architecture complements this mechanism, allowing each component to have its own state variables and adjustment rules, capable of adaptively adjusting learning rates or other hyperparameters.

In one or more embodiments, the Temporal Pattern Compliance Mechanisms are configured to be applied to a cloud or edge computing implementation where modules reconstruct historical system states or simulate future states to optimize fleet scheduling, cargo handling, or navigational tasks. Modules are configured to migrate between servers or platforms in real-time while maintaining global state integrity. Narrative Transportation system under Temporal Pattern Compliance Mechanisms may trigger Narrative Value Exchange Evaluator for entropy planning, re-structure, and resolution. Wherein the system may dynamically compute updated domain-specific energy representation, which the adjustment parameter set including but not limited to rate of Uncertainty Tolerance, Time Window Size, Coverage Threshold, Deadline, Rollback Budget, Objective, Strategy Identifier, Policy Rule, Redundancy Threshold, Context Information, Dynamic Frequency, Amplitude, Potential Force, Robustness Index, and Trust Index comprise various parameters within the system, previous symbols can include embeddings, probability distributions, or hidden states.

To set an ultimate output value to align output entropy efficiency target, adjusting parameters based on current state and destination factors. It is configured to detect changes or adjust parameters of the system accordingly, improving overall consumption and responsiveness of the endpoint.

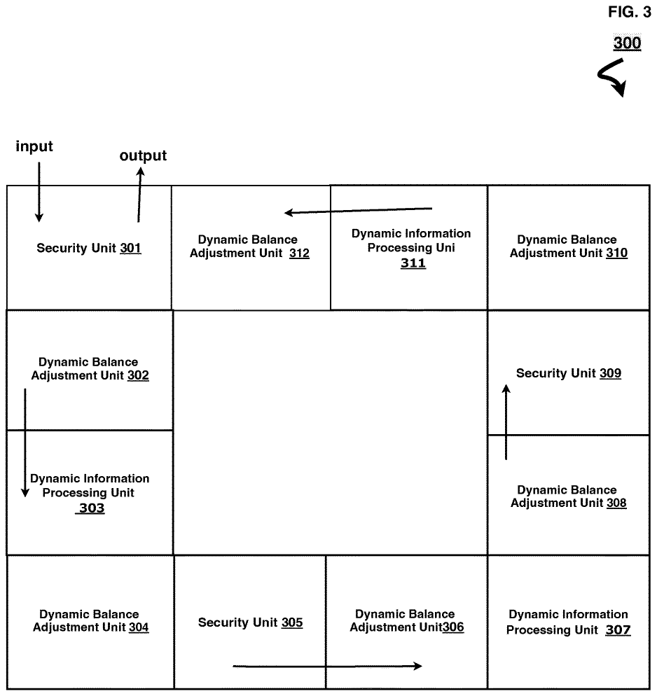

FIG. 3 illustrates a flowchart depicting a mechanism and Feedback Loop process 300. This includes but is not limited to a set of core principles from Emotional Entropy Exchange system. In certain embodiments, the Self-Resolution model is configured to dynamically determine which module is activated for a given input by employing events that trigger conditional responses under rule-driven mechanisms selected from Parameter/Method/Rule Set and Storage module. The input is processed in a loop with the following units: 301 SU is configured to trigger the processing. 303 DIPU is configured to process and compile the input data. 305 SU is configured to trigger the operation and improve security during processing. 302 DUAU is configured to dynamically monitor the system, re-structure resources optimization. 307 DIPU is configured to integrate and process the data further. 304/306/312 DABU is configured to monitor, adjust, and optimize the processed data. 307 DBAU is configured to dynamically monitor the system structures and resources optimization again. 307 DIPU is configured to further process and integrate the data. 309 SU is configured to enforce security during processing. 310 DABU is configured to optimize the processed data. 311 DBAU is configured to dynamically monitor the system structures and resources optimization again. 311 DIPU is configured to further process and integrate the data. This loop continues until a certain output standard meets the predefined threshold. The final output is guided by the 301 SU.

The system incorporates the Multi-Dimensional Self-Resolution feedback loop circle which transforms entropy into tradable, accumulable energy contracts that require settlement. This system dynamically diverts energy and enhances Self-Resolution and problem-solving capabilities through multiple estimation models paired with a visual dynamic logic multi-dimensional conversion control panel and a full-scale projector generator. The mechanism is configured to prevent unauthorized reproduction of system design at the architectural level, improving structural arrangements cannot be imitated or repurposed without explicit authorization. This is achieved by providing a Value Exchange Evaluator, Transportation system, Entropy Scale system, secure password compression mechanisms, intelligent safe energy conversion contracts, and Meta-Language, all working together to provide the highest principles for the entire system.

For instance, if an input exceeds a threshold, the Multi-Dimensional Self-Resolution model is configured to self-adaptively invoke a corrective module based on task-related features extracted from the input, including but not limited to Spatial Domain, Instruction Type, and Expected Output Format. The system model conducts multiple analyses of the input, allowing it to self-adaptively invoke different Interspecies Brain-to-Brain Interface, Quantum Cognition, Empathy, Neuro-Existentialism, Predictive Processing models under Review Committee Mode analysis if initial analysis is unable to recognize the input.

In one or more embodiments, the system is configured to enforce integrity of structural configurations by binding topological arrangements to authorization metadata stored in plan records. This is configured to ensure a Electroencephalogram and Neuroengineering system that when a requesting entity attempts to mimic or alter structural arrangements, the framework compares the proposed structure against the authorized topology hash. If the structure deviates or lacks authorization, execution is rejected, and rollback is triggered. In these embodiments, one or more components described herein may be implemented using ASICs, FPGAs, programmable logic, NPUs, custom accelerators, distributed processing systems, or other later-developed hardware architectures.

The disclosed components and processing stages are defined according to their functional relationships rather than any fixed implementation form. Accordingly, individual components may evolve to process richer, multi-modal, hierarchical, latent, or later-developed data representations while remaining within the disclosed architecture. Likewise, intermediate transformation stages, hidden computational layers, routing mechanisms, abstraction layers, or dynamically generated processing operations may exist between disclosed components or method steps without departing from the scope of the present disclosure.

In yet another embodiment, the system is deployed as a multi-tenant service accessible via APIs such as REST or GraphQL. Each dataset provided for training or inference must include a cryptographic signature linked to a DID; otherwise, the framework adapter rejects the data. Similarly, trained model parameters, embeddings, and intermediate representations are stored with tamper-evident metadata, such as cryptographic hashes and authorization identifiers. Any attempt to export or replicate such parameters triggers verification of authorization metadata; unauthorized export requests are blocked by the system.

By embedding the system into different domains, it may operate on distinct data modalities while preserving overall coherence through the framework. For instance, AC may receive biological signals in healthcare contexts, financial transactions in risk assessment contexts, or atmospheric data in environmental contexts. Regardless of domain, the mechanisms and logic remain interoperable, improving functional integrity.

In one or more embodiments, for each user query, AC is configured to actively interact with input data to widely collect information; filter collected information through noise reduction and feature extraction, retaining only Essential Features related to the Meta-Core Engine; execute multiple candidate strategies in parallel after receiving input and evaluates responses by Level-Based Classification of Data Uncertainty generated by each strategy using including but not limited to Distributed Neural Networks, the sub-component reversibly self-adaptively selects the optimal path. For high-confidence, low-risk paths, AC directly generates output after pre-processing to meet certain standards chosen from PMRSS. Output cooperates with Sorting module of DBAU to generate a further plan including but not limited to strategies, rules, frameworks, or arrangements.

In one or more embodiments, the system applies Self-Resolution and Feedback Loop methods in defense system to enhance resilience for cybersecurity. The system is configured to input raw data; output refined data, including but not limited to essential features (value signals). Consistency Check is activated to improve decision efficiency and security for paths such as low-confidence, low-risk; low-confidence, high-risk; high-confidence, high-risk; and high-confidence, low-risk while simultaneously pruning high-confidence, low-risk paths. Consistency Check applies one or more Review Committee Methods including but not limited to Self-Consistency and Self-Correction to verify whether the input, output, and logical process are consistent. Inclusive of Data Pool, Logic Loop Testing, Rule and Method Set, Real-Time Evaluation modules, and updates New Parameter/Method/Rule Set Unit to generate a Viable Output for the next step.

In one or more embodiments, the system applies the system for a Distributed Computing Ecosystem for Urban Biosynthesis. With the NEES, the ecosystem may apply Thermodynamic Ledger with Digital Alchemy Rule for Energy Credits Token. The input data is processed through a multi-stage transition AC pipeline. The system may compute the real-time energy flow of waste materials throughout the city (including but not limited to phosphorus in wastewater, carbon in the air). Closed-Loop System is configured to execute allocation of all resources within the ecosystem with Smart Cities Legal Contracts by the underlying blockchain code. Trigger signal for AC is generated when one or more predefined conditions on input data, system state, or parameters are satisfied, causing the system to execute a subsequent processing operation. The system is configured to monitor the electrical signals from plants' leaves, and symbolic logic locks down the flavor boundaries.

The system is configured to enforce Self-Resolution as the multi-modal perception module. AC may invoke different sub-modules, including but not limited to Structured Meta-Language System, which is configured to convert multimodal data into a unified representation; domain-specific sub-modules, including but not limited to Algorithmic Determinism in Mental Health, Affective Telepathy via BCI, Neuroarchaeology Paleopsychology, Evolutionary Affective Neuroscience, Epigenetic Trauma Inheritance, Plant Neurobiology and Human Interaction for training Collective Consciousness, Internet of Brains and Hive Mind Engineering under Dynamic Spatial Reaction Pattern Cryptography Mechanisms. The system is configured to explore feature relationships, extract high-level features through deep learning. Before sending the final output to Sorting module, AC reviews and revises data, inclusive of constitutional AI and a parameter set containing policies, rules, and strategies.

In another embodiment, the system enforces policy constraints preventing unauthorized derivative use. Specifically, units are configured to block retraining, replication of logic structures, or mimicking of semantics and topology unless authorization metadata has been validated. For example, when an external client attempts to extract embeddings or replicate structural configurations of a directed acyclic graph (DAG), the system checks authorization credentials bound to a DID. Without successful validation, such derivative operations are denied and rolled back.

In a further embodiment, outputs generated by the system incorporate embedded watermarks or fingerprints, enabling subsequent verification of derivative use. For example, certain versions of outputs may include imperceptible token-level watermarking, while another part of the outputs may include frequency-domain watermarks, and embeddings may incorporate fingerprint vectors. Verification modules can later detect these marks to confirm authorized use. Additionally, rules or logics executed by the system, such as dynamic programming, probabilistic inference, or proprietary optimization routines, are represented in the IR with annotations linking execution cost, latency, and uncertainty. Structural configurations such as flowcharts, block diagrams, and topology schematics are generated only upon validation of authorization metadata, thereby preventing unauthorized graphical reproduction of system architecture.

In one or more embodiments, this Compliance Mechanism Framework is utilized to establish an academic system capable of detecting AI crawlers and counter-surveillance systems. The framework can receive real-time feedback-loops for evidence sharing and crawler reports from the entire network. Additionally, the Review Committee Mode may be employed to interface with a real-time copyright tracking system, enabling comprehensive scanning of AI infringement content across the entire network.

Furthermore, the system may set up, including but not limited to, traceable copyright protection encryption and digital watermarking, JavaScript Validation and Dynamic Loading, Data Fingerprinting, scheduled automatic uploads of mirror websites and updated versions to the blockchain for evidence preservation. All comments, uploads, and modifications are bound to a DID. This embodiment enables the detection and mitigation of unauthorized uses of intellectual property, thereby promoting compliance with relevant laws and regulations.

In one or more implementations, the system is configured to apply AOKR destination generation Mechanisms in a dynamic Multi-dimensional Transition and Projection system to dynamically allocate data within the co-shared Spatial Reaction Pattern Module's target-land Engine. AC is configured to employ a handshake protocol on the API of the target process to establish communication. The system is configured to search for specific numerical addresses and values, locks onto a memory address through multiple changes to that value, and forcefully modifies it; Buffer Mechanism is configured to overwrite adjacent memory space, including the function's return address. The system is configured to lead the CPU to transit to a specified code address after executing the cryptography mechanism's instruction; Transportation system is configured to configure a section of memory within the target process space and adjust the code execution path in memory effectively altering the program's behavior.

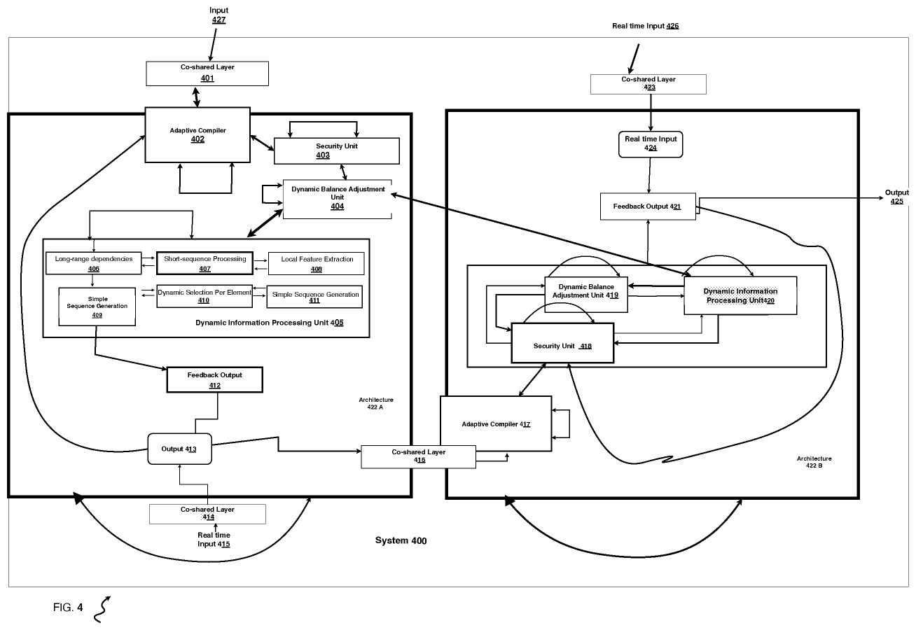

FIG. 4 is a flowchart illustrating a Meta-Learning inference process of the system under two different system structures but under dynamically re-configuration and Self-Resolution model. This information processing and inference utilize Self-Resolution model to enhance reasoning accuracy and reduce bias rates. The neural network system includes an internal evaluation rule-based data transduction neural network with one or more sub-networks, subsystems, and modules such as SU 403, DIPU 405, and DBAU 404. This system is implemented via computer programs on multiple computers. The architecture is configured to handle an extensive spectrum of data types, encompassing modalities from spectroscopy and chromatography to frequency, context, space, time, system logs, thermodynamics, temperature, pressure, entropy, physics, and other disciplines.

Co-shared layer 401 is configured to filter and exchange data based on one or more rules under the Feature DIPU 405, which is configured to explore, generate, and evaluate extracted features and produce output results. Long Range Dependency module 406 is configured to capture and process information across multiple modules. Short Sequence Processing module 407 is configured to handle smaller, more localized sequences of data. Local Feature Extraction module 408 is configured to focus on extracting local features from input data. Simple Sequence Generation module is configured to create simpler and manageable data sequences. Dynamic Selection Per Element module 410 is configured to optimize performance by dynamically selecting elements. Real-time inputs 415 may include predictions, classifications, or other derived information based on processed data. The system may also use fine-grained graph partitioning with dynamic schedules. DBAU 404 includes a dynamic adjustment and alarm mechanism, which triggers rollback upon policy violation. Policies may include: Scheduling being downgraded to safe mode.

In one or more embodiments, the Real-Time Evaluation Mechanism is integrated into the system by analyzing data to generate optimized strategies or instructions. The system transmits these instructions to SU 418, DIPU 419, and DBAU 420, creating an intermediate representation. The DIPU 419 returns new state information, which the DBAU 420 uses to adjust strategy and re-issue instructions. The mechanism collects real-time feedback inputs from Real-Time Input 415/426 and internal feedback loops, converting constraints for the next round of generation. This evaluation may also be performed by one or more Aesthetic Assessment components, which quantify generated results based on predefined rule libraries (including but not limited to Harmony Rates and Balance Rates) or trained classifier models. The resulting score serves as an optimization objective. SU 418 may send trigger signals, improve data security via encryption and decentralized storage, while the mechanism provides lightweight computations suitable for edge computing by real-time interactive visualization. This mechanism employs a Feedback Loop, continuously comparing system outputs with target objectives and generating corrective actions when deviations are detected. For example, in a robotic system, the Feedback Loop dynamically adjusts force and trajectory based on real-time data. Policies can adjust parameters including but not limited to Functionality, Reliability, Cost, Yield, domain-specific energy parameters, target state of ultimate value, domain-specific spatial relationship parameters from its mechanisms, Amplitude, Potential Force, Robustness Index, Trust Indicator, domain-specific alignment or initialization strategy, or Applicant-defined parameters. Real-time inputs 415/426 is configured to enter the system through a dynamic interface, providing continuous data for processing.

DBAU 416 is configured to dynamically adjust its position and configuration based on real-time input data, optimizing resource use. Co-shared layer 417 is configured to optimize module placement through multiple iterations. Long Range Dependency component, Local Feature Extraction component, Short Sequence Processing component, Simple Sequence Generation component are configured to repeat steps until a result is achieved. DBAU 420 dynamically adjusts its position based on real-time input data, improving resource use. SU 418 is configured to trigger the operation, enforce secure interactions during dynamic adjustments with strategies like graph message passing or hierarchical messages passing. Feedback Output 421 is configured to transmit output results to the feedback loop for further training. Outputs are configured to be complex patterns, simple scalar values, or strings. The final output 425 could be a prediction, classification result, or other derived information based on processed data. This may be implemented using queue-based batch merger in the serving engine.

In some embodiments, AC 402/417 is applied in a Multimodal Forensic Smart Contracts system as a self-contained loop system within the larger framework of the planetary surface transport system under the Self-Resolution Mechanisms. These mechanisms integrate inputs from both SU 403/418 and its own dynamic adjustment modules, configured to reduce storage overhead while preserving verifiability. The process flows as follows: input data is received, information is extracted; relationships are identified based on the extracted features; logical outcomes are derived from identified relationships; The feature update is performed through verification and logic loop, repeating until verification results are true. First-round validation results are based on viable output and real-time input data. Feedback is generated from the first-round validation; updated features are combined with feedback data for further processing; information extraction and logical outcomes are derived from the combined input until validation results are true. Real-time input data is adjusted based on the feedback loop. The final output is determined by the validation results and updated real-time input data.

In one embodiment, the system is applied as a neural network system in Neuro-linguistic Programming for Human-Computer Interaction using an attention-based neural network and with the Self-Resolution model to improve performance in reasoning with minimal resource investment. The inference candidate components are applied with the system as a sub-system. The output formats can vary, represented in various forms, from multidimensional that hold complex patterns to simple scalar values and strings that convey essential messages across cosmic distances. Both static and dynamic output structures are supported under one or more configurations depending on specific requirements and operations of the system at any given time. Additional components may be included as needed, and the configuration shown is merely illustrative. The final output 425 of the system, which could include but not limited to a prediction, classification result, or other derived information based on processed data. This may be implemented using queue-based batch merger in the serving engine.

In one or more embodiments, the inference process and logic flow comprise steps including but not limited to real-time Dynamic Safe Exploration Sandbox, Motivational Insight, Consequence Simulation, Stress Testing mechanisms, and Innovation Catalysts. These components intersect with digital identity, smart contracts, and blockchain technologies. Each new parameter and rule set is dynamically updated in the model, allowing for certain parameters to have a degree of self-correction. The system is configured to dynamically learn the inevitability of randomness, enforcing that this screening process is not influenced by systemic biases, thereby preserving its purity of randomness. Wherein, logic modules including but not limited to: Dynamic Safe Exploration Sandbox, Motivational Insight, Consequence Simulation, Innovation Catalysts, Stress Testing, or other Applicant-defined parameter inference methods.

Each step has one or more Intermediate Representations (IR) and using patterns with information from each of the input. For each intermediate representation, there exists a pattern that is informed by the information from the input features. The Information Representation module possesses an independent sub-module where data, after being refined, compressed, and learned through encryption processes, is stored under Cryptography Mechanisms. This mechanism is configured to facilitate the retrievability of the traceable logical chain, providing the logic flow to audit. AC is configured to act as a loop system that includes both DBAU and DIPU within its operation. The outputs from SU, DBAU, and DIPU are processed together in the AC to dynamically adapt strategies based on real-time data. For example, in a deployment scenario, the logic flow may be used in real-time tasks for Disaster Reconstruction and Crisis Restructuring infrastructure Socio-Technical System, where predictions rank alternative tasks by urgency and clarity. The inference process could be realized as a Python process utilizing a PyTorch at hybrid-time to execute the model weights resident in GPU memory.

In one embodiment, the system is deployed as a network-accessible service. Input requests are received via an API, such as REST or GraphQL, and are passed through framework adapters. Prior to execution, requests are validated against metadata policies and DID-based authorization tokens. The Feedback-Loop, Closed-Loop Alignment, Logic-Loop Testing, Prediction Consistency Check or Level-based Classification of Data Uncertainty methods are executed under frameworks, and results are returned to the requesting client with audit logs. This system may enable multi-tenant operation in cloud or edge environments while improving authorization and rollback guarantees.

In one embodiment, our system is applied in a psychic control simulation system that integrates with one or more external systems to improve performance. The inference candidate components are integrated as sub-models within a neural network framework. These components can optionally employ statistical regression and machine learning algorithms for parameter updating under a Multi-Dimensional Self-Resolution model.

Based on data analysis, predictions are performed in the mechanism using Emotional Entropy values or Applicant-defined optimization, allowing the system to accelerate prediction. The data from external systems is integrated into a unified meta-system through the Narrative Transportation system, NEES, and Narrative Value Exchange Evaluator. This enables various heterogeneous subsystems to freely grow within the framework, providing multi-modal, quantifiable, and visualized indicators for data that can enhance efficiency, performance, and reusability.

The Spatial Reaction Pattern module is configured to understand data and triggered by the Temporal Pattern Compliance Mechanism under Event-Driven or Stream modes. This allows for the collection and fusion of multi-source data to select logic-based models for the next processing step. Candidate components such as the Spatial Pattern Topological Transformer Module are configured to compute reasoning factors based on parameters under a Real-Time Evaluation Mechanism. Candidate components like the Spatial Domain Module adjust reasoning thresholds and model parameters according to historical and real-time feedback. The candidate components are triggered by platform-independent rules, including system-wide balance, development rate, bias rate, optimization level, memory and precision regulation, and dynamic compilation trigger strategies such as hotspot thresholds. Feedback-Loop mechanisms also play a role in this process. Additionally, the Temporal Pattern Module is configured to generate and transmit early warnings based on adjusted thresholds.

In another embodiment, SMLS is used to improve the uniformity and security of virtual currency transactions within an Cryptocurrency Currency system. The SMLS is configured to enforce integrity in transaction validation and execution by binding each transaction term (including but not limited to a token or identifier) to a version number and authorization token. During transaction processing, terms are validated against a canonical vocabulary table to prevent unauthorized modifications. Any attempt to introduce modified, mimicked, or unauthorized substitutes is rejected, enforcing that transactions cannot be replicated without proper authorization.

SMLS may improve language uniformity throughout the system for efficient internal module identification and external API access and may adaptive compiled inputs into executable representations as an adaptive compiler. SMLS is configured to support integrated processing of various topologies depending on the computing paradigm used, including but not limited to chain structures in different way of computation, including but not limited to quantum gate networks in quantum computing, and optical fiber or waveguide arrays in photonics. The system includes a dynamic adjustment and alarm mechanism trigger from SU, which comprises a set of policies that trigger rollback upon policy violation. Said policies may include but are not limited to scheduling being downgraded to a safe mode; the system is configured to revert to prior plan versions.

The policies comprising this mechanism include at least one of Dynamic Adjustment Policies, Real-Time Evaluation Policies, or Applicant-defined policies. Upon calculation and monitoring reaching a dynamic decision point, the system dynamically adjusts predefined parameters, including but not limited to: Uncertainty Tolerance, Time Window Size, Coverage Threshold, Deadline, Rollback budget, Objective, Strategy Identifier, Policy Rule, Redundancy Threshold, Context Information, or Applicant-defined configuration parameters. The system is configured based on, but not limited to, conflict and decision point considerations with respect to the Dynamic Adjustment Policies.

In certain embodiments, the system is applied for Human-Artificial Intelligence Cognitive Interaction prediction neural network system. To transform human cognitive into data that can be read by the system, the system does not rely on linear algorithms but instead uses Mapping Algorithms including but not limited to graph, crossed to perform holographic correlations in Spatial Reaction Pattern modules on all data. This process is based on a dynamic adjustment parameter set, which includes but is not limited to: Dynamic Frequency, Amplitude, Potential Force. These parameters are used to calculate mapping routes through multiple quantum structural superpositions, ensuring that all mapped data is included in the resulting optimal combination of data imagery to generate more accurate predictions to meet the output standards including but not limited to Resonance, Contextual Relevance, Pattern Recognition, Creativity Level, Bias Rate.

In certain embodiments, the system is configured to apply Emotional Entropy Principles for dynamic training strategies. The dynamic training strategies are employed to facilitate collaboration among nodes within the system. Training strategies may improve objectives, constraints, and optimizations that all nodes collaborate based on shared goals and trust-based interaction rules, including but not limited to system balance and prediction accuracy improvement, evaluating key patterns, holographic correlations, logical and structural superposition, and prediction errors stemming from overly complex functions.

In one or more preferred modes, the system is built with Structure-based modules configured to collect data and process feature and risk assessment, receive and upload input data from one or more external sources, compute the difference of the inference output and real-time data, re-apply the difference for the next round model training as optimizing parameters, dynamically trigger rearrangement of modules or generate one or more further candidate modules, or execute rollback when performance does not satisfy a threshold metric; convert uploaded data into structured data according to a predefined schema; process different mechanisms, generate viable output, provide the structured data chain across the distributed ledger; enforce submission, querying, and verification of the structured data, where cryptographically stored, tamper-evident, and traceable throughout its lifecycle by applying including but not limited to self-learning, prediction, analysis, initiation, conversion, monitoring, crisis management, simulation, and post-event reconstruction.

In further embodiments, dynamic training strategies may contain Emotional Entropy nodes, each initialized with an entropy value when created. During the neural networks training phase at any given time, the entropy value of a node can decrease due to exchange events or increase due to new information (including but not limited to deeper exchanges). Thus, the Emotional Entropy value of debt at time t can be expressed as the relationship between Emotional Entropy values repaid at time t and new entropy values added at time t. This may comprise including but not limited to: one or more independently developed, cross-disciplinary Emotional Entropy Principles as fundamental principles to govern the exchange of value within the system; one or more Emotional Entropy Ledger Tools for tracking and managing emotion entropy values; one or more sets of parameters, rules to define, estimate, convert, and manage ME for setting expectations and controlling the pace of fulfillment; one or more ecosystems providing tools such as a ME calculator software, case studies, and certification standards. This system is configured to evaluate whether a node is effective by determining if the actual output exceeds expectations and whether it helps the system decisively eliminate low-efficiency components. The framework is easily disseminated and understood, with cross-domain integration facilitated; it reduces irrelevant components, focusing on value exchange and security mechanisms. It may be implemented as tools such as Emotion Energy Ledger to enhance creativity across interdisciplinary systems.

In certain implementations, the meta-system may apply Narrative Transportation during dynamic training strategies for moderate parameters for all logics, methods, rules, or mechanisms according to different functions including but not limited to sum or decreasing. Wherein Emotional Entropy confusion arises where should dynamic be decreased over time by each round training; when High Emotional Entropy indicates multiple possibilities coexist; Low Emotional Entropy signifies emotion convergence to a single state; borrowing Emotional Entropy involves introducing Uncertainty into the system training-borrowing data uncertainty from the ecosystem; calculating Debt costs involves each Debt having an Interest—the patience cost other nodes incur while waiting for exchanges. Before the system's entropy increase beyond predefined thresholds, the system may apply Self-Resolution model to improve system meta-learning ability, creativity and pay Emotional Entropy interests for entropy planning, re-structuring, resolution; maintain Emotional Entropy liquidity. This may keep a certain ratio of the system (including but not limited to IRI, IC, LTV, CTAC, MC, NEW, YOY, ROI, OL, MGC or GPM) in a dynamic balance way across nodes according to industry-specific tailor ratios, thereby achieving resilience and self-adaptively ecosystem.

In certain embodiments, the Narrative Value Exchange Rule is applied to the system, allowing for the setting of relevant models based on industry and system-specific requirements. The constitutional rule contained within this model may be composed of a set of parameters, including but not limited to Narrative Value factors, Red Team Testing factors, sandbox testing factors, Consciousness factors, Fatigue factors, openness factors, diversity factors, creative resilience factors, computational resource factors, storage space factors, network bandwidth factors, and module security factors. These factors serve as the common goals and framework parameters for the system's internal modules, operations, interactions, and reasoning processes.

The Dynamic Safe Exploration Sandbox may be used for experimentation under higher Emotional Entropy Module Economics ratios in hybrid-time based on specific task requirements and conditions, including Data Uncertainty Rate selected from PMRSS. The experimental results are returned to IR for method and summary and undergo multiple logical and factual confirmations before being stored in the parameter set. Identifiers are associated with parameters, methods, versions, processes, access records, interaction records, and bind these with DID and at least one of a sequential index, timestamp, cryptographic hash, or applicant-defined compliance marker to form a transparent chain.

In one embodiment, the system is applied as an underlying meta-system for integrating one or more external systems to enhance efficiency, performance, and reusability of components. The system is configured to process input data through a group of transition and recording operations to generate a verifiable output. The framework is configured to allow various heterogeneous candidate components to grow innovatively within the system. The system is configured to trigger protective mechanisms defense includes but not limited to: preventing internal combustion, single points of failure, excessive internal coordination protection, inheritance gaps, V (NVA) (No Value Added), including but not limited to random walk, toxic assets. Parameters are dynamically selected from the ME module, including but not limited to: risk-free rate, underlying assets, Sharpe ratio, earning power, brand equity, goodwill, and resource allocation degree.

In one or more embodiments, a Self-Resolution Emotional Entropy Exchange Consciousness Capital Infrastructure platform system may apply the Cognitive Asset Architecture and Foundation integrated framework to the meta-system dynamic data training strategies. The platform is configured to serve as a value carrier that can integrate with global resources, infrastructures, intellectual properties, circulation levels, trust coefficients, and risk management. The system is dynamically configured to monitor the state of other nodes in the system, detecting any unexpected events or anomalies that may arise, including but not limited to insufficient energy consumption, storage overload, policy violation, or the Emotional Entropy. Assuming each node has an Emotional Entropy value, the triggering threshold condition could be according to indicator function. The system may trigger the alarm for the next step if the system processing output meets certain threshold conditions. Upon detection of such an event, a component may trigger a rollback or fallback mode, wherein one or more other components self-adaptively take over traffic based on task relevance and share the load until the original component returns to its normal state. This mechanism may improve collaboration among nodes in the system, enforcing continued operation and minimizing disruptions due to unexpected events or anomalies. Under the guidance of cryptography mechanisms, multimodal data from sources such as global geological surveys, satellite remote sensing, mineral reserve reports, energy agency data, infrastructure registries (including but not limited to highways, railways, power plants), infrastructure databases, and publicly available information from national statistics bureaus and patent databases are collected. Review Committee Mode may be applied to each sector. Wherein Review Committee Mode may also be applied to convert units from various domains and industries, along with “intangible” energies, into assets that are anchored to a unique temporal pattern and are auditable according to the principles of Emotional Entropy. These assets, valued under a comparable target state value system, can then undergo rapid exchange through Narrative Transportation system and Narrative Value Exchange Evaluator, ultimately achieving compliance effects. Within the Data Collection module governed by Co-shared modules and AC, these multimodal datasets are read, extracted, and distributed. The DBAU-guided Spatial Domain Module establishes a feature engineering module for computing resource index increments contributed by new reserves to the global pool. Under the direction of the DIPU-guided core calculation module, the Spatial Pattern Topological Transformer Module records added value, synthesizes it within a combined value engine to calculate the new issuance quota. Following the guidance of the SU-guided Temporal Pattern Module, the platform authorizes, generates smart contracts, Self-Adaptative mints new coins, and deposits them into user wallets (with locked purposes). Simultaneously, it updates alerts for various parameters such as asset bubble warnings, resource depletion warnings, integrity communication consensus data warnings, speed warnings for talent exchange, logistics, trade, and turnover, transaction supervision mechanisms, issuance discipline, monetary policy rule warnings, intellectual property and social consensus data warnings, infrastructure asset data, and mineral resources, energy reserves data warnings. Users can query the real-time coordinates of the currency, reserve reports, and local verification documents at the customer output end. The system is configured to cross-reference with international cryptocurrency reserve databases for real-time comparison and dynamically adjusts parameters based on transaction supervision mechanisms. It performs dynamically detection, perceives global data, calculates its intrinsic currency value, adapts to environmental changes, and iterates risk responses.

The system is configured to apply one or more hybrid-time optimization, constraint, strategies, operation, policies, rules from Temporal Pattern Compliance Mechanism module parameter sets to train the meta system. The parameter sets comprise from at least one of: Resource Utilization factor, Short-term Profit factor, Reward Function factor, Causal Feedback Function factor, Trading Policies factor, Penalty Metric factor, Asset Flow Dynamics factor, Resource Distribution factor, Trading Risk Profile factor, Liquidity factor, High-Risk factor, Leveraged exchange Strategies factor, ROI factor, Long-term Systemic Risk factor or Applicant-defined parameter within the PMRSS. These rules and parameters represent domain-specific regulatory processes that enable the framework to function across complex environmental or operational conditions. Each of the factor includes one or more functions, rules, or framework for computing. By embedding these rules and mechanisms parameters into the system design, the system may achieve robustness and adaptability under unpredictable or extreme conditions. Wherein one or more parameters for optimization strategy, objectives or constraints are configured to be applied and computed based on one or more conditions from Resource Utilization Rate, Causal Feedback Function, Systemic Risk Metric, system action or Applicant-defined conditions.

In one or more embodiments, the system is configured to apply Temporal Pattern Compliance Mechanism modules which comprise one or more metarules rules, defining the system's ultimate objectives and value judgments, including but not limited to Emotional Entropy Exchange Principle as objective. The objective is configured to maximize resource efficiency, encouraging each transaction, node, and system tool to fully utilize their value, avoiding waste. Strengthen causal loops by reinforcing positive feedback within the system, such as stable exchange behavior and reduced systemic risk: Risk Control and Long-term Stability are configured to prevent short-term speculation and zero-sum transactions from having negative effects on the system's health. Allow the system to naturally converge towards a healthy state; AI Strategy is configured to decide what actions to take in each state based on AI policy. In strategy selection, incorporate constraints: resource usage limits, systemic risk ceilings, and prohibit zero-sum behavior exceeding those limits; Causal Reinforcement Learning/Model-Based Reinforcement Learning is configured to learn behavior mappings from the system's overall ecological environment state to causal effects. Prioritize behaviors that produce positive closed-loop impacts; Reward Shaping is configured to impose negative rewards for wasteful resource use or closed-loop destruction and amplify positive rewards for long-term stable behavior or high-efficiency performance; Alignment Strategy is configured to quantify market targets: wherein healthy system target includes but not limited to high-resource utilization, causal loops, long-term stability. Dynamic Adjustment Mechanism is configured to adjust parameters to prioritize different targets, such as increasing indexes for short-term speculation that may disrupt closed loops or adding parameters for severe resource waste issues. Feedback Mechanism is configured to observe system state changes and use actual feedback and target deviation to adjust rewards after each decision.

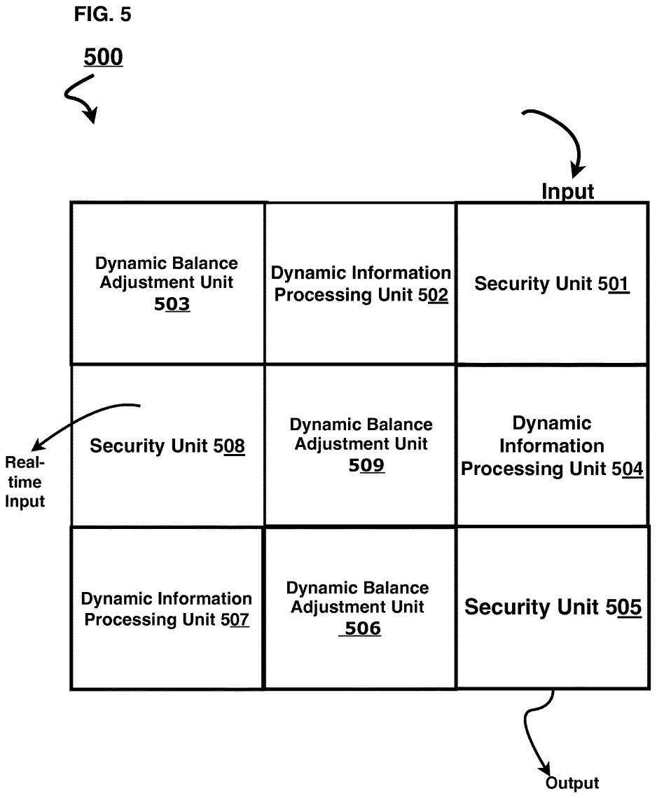

FIG. 5 is a flowchart illustrating a multimodal state-space model transit process of the system under dynamically re-configuration and Self-Resolution model. In some embodiments, the system is configured to be applied as the Logical and Components Interactive Transition Inner-Interfaces for a High-speed data transfer real-time module system. After establishing a connection with the SU 508, and following the trigger signal of the SU 501 Temporal Pattern Compliance Mechanisms, the compiler is configured to initiate component for Root Access API Endpoint module which operations within the Co-shared Spatial Reaction Pattern Module for multi-modal data analysis in sandboxes. It is configured to capture real-time coordinate positioning, performs code editing and data routing, and generates an execution diagram.

DBAU 502 Skeleton Construction Protocol is configured to use various Pattern Cryptography mechanisms to dynamically adjust parameters. It is configured to include the SU 505 with Life System Activation and Regulatory Balancing mechanisms for Sleep Mode or Background Process, the DABU 506 with Reaction Vessel mechanism and DIPU 507 with Dynamic Biological Carrier Protocol are configured to complete the necessary topological readjustment for the energy exchange protocol within the Spatial Pattern Topological Transformer Module.

DIPU 507 is configured to apply Dynamic Biological Carrier Protocol for monitoring Firewall or Encryption mechanisms between different components. DIPU 509 is configured to handle topological readjustments required by data from exchanges in terms of time, space, and energy under Dynamic Activation Rendering mechanism for Error Handling or Debugger; DIPU 503 is configured to execute data analysis, inference, and preliminary tracing are established with the output ports through various handshake protocols of the interaction protocol, including but not limited to frequency resonance, Alarm or Interrupt Request, for real-time takeover of each component; DUAU 504 is configured to apply Real-Time Inspection Activation and coordinate the target location's coordinate positioning by SU 508 for the Display Output needs. The structural configurations of modules are represented abstractly as nodes and edges in a graph. Each edge is annotated with including but not limited to policies, or data information. Graphical depictions including but not limited to module diagrams or flowcharts are Self-Developing generated from this abstract representation. Reproduction of such visual forms is permitted only with verified authorization metadata, thereby preventing unauthorized mimicking of graphical structure or topology.

In one or more further implementations, the system is configured to be applied for a life science platform. Compliance Mechanism is configured to assist with Deep Packet Inspection methods, self-adaptatively to intercepting all traffic at the co-share layer gateway. Unqualified request is configured to be locked down for ensuring the system core engine remains uncontaminated. Deterministic Latency Delivery Mechanism is configured to validate interactions through rigorous identity and environmental checks. Data flows are configured to be granted access to the buffer only after passing these dual validations under Measured Delivery Mechanism. Scheduler Monitoring is configured to real-time monitor of system status, ensuring immediate response fluctuations be rejected until specific thresholds are met before results are output.

In one or more further implementations, the system is configured to perform a multi-module structure build for a multi-dimensional transition system's training. Despite integrating multiple different systems and algorithms, the overall system's Meta-anchor, world model constitution, and monitoring module's stable flow control risk, together with

NEES' unified conversion method and interface format, enables the integration of different computing environments within and outside the system. The system is designed to provide speedy response while simultaneously ensuring consistency, usability, and partition tolerance: the underlying layer uses the meta-system to provide Consistency ability of the system to maintain a consistent view of data across all nodes in the distributed system; the middle layer can interface with existing algorithms for fitting the narrative target and optimize neural network parameters for usability and accessibility of the system for predefined users; the supervisory layer can integrate Temporal Pattern Compliance Mechanisms to enhance partition tolerance as the ability of the system to continue functioning even if some nodes or partitions fail. The system is configured to extract surrounding elements of Emotional Entropy flow instantly, processes them with a virtual module based on the expected energy flow and demands within the target location, and reconstructs them there. After receiving the trigger signal, the process is configured to be passed through DIPU 507 with Real-Time Inspection Activation mechanism and overlays for the final closed loop formation in an independent target location to output corresponding outputs. After receiving the protocol from DIPU 504 for Dynamic Memory Allocation, the output is inspected and activated for real-time loop multiple verifications. DIPU 509 is configured to compute the Vessel Update representations based on including but not limited to Hidden State, previous state; update module lost rate or other parameters from Multi-dimensional transition modules parameters set. The system is configured to dynamically determine how much of the information of the output embedding system is overwritten by the Miti-Dimensional Input. The AC may dynamically compute the parameters for fine turning including but not limited to signal-to-noise ratio, compression ratio, Storage ratio, Emotional Entropy needs, Multi-dimensional Vector Space transition rate or other parameters for generate the for the Multi-dimensional Projection module in the output module including but not limited to: signal-to-noise ratio, compression ratio, Multi-Dimensional Source, Projection Matrix, hidden state or state representation, model predicts rate or situations, estimate of the true parameter, true situation, Reset Gate at time, hyperbolic Tangent function, Element-wise Multiplication or Hadamard Product, Materialization Function, probability, loss function, base logarithm or other Applicant-defined parameters or functions. Intermediate representation of each parameter are dynamically computed through the functions including but not limited to hadamard product as element-wise multiplication. The system may measure how far the predicted value deviates from the true value, evaluate the amount of information that is preserved between the predicted result and the true result. The system is configured to convert infinite complexity into a predefined form of generation, manifest in the Physical Module, and the constrains may be dynamically computed collect form one or more rules or parameters set from fluid dynamics generation methods, the diffusion equation, or surface tension in the output module for predefined embedding. As some more embodiments, Topological variants are realized through one or more morphing engines that allow users or systems to define a set of key feature points. Self-Resolution in any one of these feature points is configured to enforce the engine to smoothly recalculate the form of all connected lines according to a set of transformation rules. This process may result in multiple Self-Resolution candidate component interacting based on hybrid interaction rules, leading to the emergence of macro-ordered structures in the generation module through a decentralized, self-organizing process and mapping them to output space continuously.

In some embodiments, the system is configured to apply self-contained loop within the larger framework of the planetary surface transport system under the Self-Resolution model, integrating inputs from both the Temporal Pattern Module and its own dynamic adjustment module, including but not limited to Spatial Domain Module, Spatial Pattern Topological Transformer Module. These mechanisms are configured to reduce storage overhead while preserving verifiability. The blockchain-based platform system may comprise: one or more upload modules configured to receive and upload input data from one or more external sources; one or more recording modules configured to convert the uploaded data into structured data according to a predefined schema; one or more encryption modules configured to encrypt at least a portion of the structured data using one or more cryptographic rule or method; one or more distributed ledgers configured to record the encrypted structured data on-chain in an immutable manner; one or more traceability modules configured to track provenance and lineage of the structured data across the distributed ledger; and one or more platform interfaces configured to enable submission, querying, and verification of the structured data, wherein the structured data is cryptographically secured, tamper-evident, and traceable throughout its lifecycle.

All executions, including dataset updates, parameter adjustments, and version updates, are bound to a DID and uploaded to a blockchain, ensuring that they are secured by Compliance Mechanisms. The embodiment can be applied to Human-Computer Interaction prediction, air quality monitoring, or ecological degradation assessment, without limitation to a specific scenario. The system may also apply one or more neural networks for the models, sub-models, including but not limited to attention-based, multi-head attention-based, retrieval-augmented, logic-based, alignment, mixed, or hybrid.

In certain embodiments, machine learning and deep learning functionality may be implemented using one or more frameworks or execution toolchains, including but not limited to TensorFlow, PyTorch, JAX, Scikit-learn, Keras, MXNet, PaddlePaddle, OneFlow, MindSpore, DeepSpeed, Megatron-LM, HuggingFace Transformers, ONNX Runtime, XLA, TVM, Triton, Ray, Flink-ML, Horovod, RLlib, and Stable-Baselines. The inference process may be realized as a Python process executing GPU-resident model weights using PyTorch, TensorFlow, CUDA kernels, or equivalent GPU acceleration stacks, with FPGA or ASIC modules optionally offloading compute-intensive operations while CPU components perform orchestration.

Implementation may use including but not limited to Python, Go, C++, Java, Rust, or other programming languages, and may employ Flask, FastAPI, gRPC, REST, WebSockets, CUDA, CuDNN, NCCL, OpenCL, Vulkan compute, MPI, Kafka, RabbitMQ, Redis Streams, Pulsar, Pub/Sub, PostgreSQL, MySQL, SQLite, ElasticSearch, ClickHouse, Cassandra, or similar technologies. Cryptographic and decentralized identity functions may be realized using Hashlib, DID-resolution libraries, Merkle-tree hashing, digital signature verification, or zero-knowledge proof mechanisms.

Deployments may utilize containerized microservices orchestrated by Kubernetes or equivalent cluster managers, exposing gRPC or REST interfaces for inter-service communication. Distributed tracing, live metrics, and real-time observability stacks may provide monitoring and operational assurance. The system may be hosted across public cloud, private datacenter, on-premises clusters, edge devices, or hybrid environments without architectural modification.

In one or more embodiments, the system is applied to a compliance audit platform. The platform comprises an ingestion gateway under co-shared module that receives multimodal input from multiple sensors across various channels, each input being time-stamped upon ingestion and associated with metadata including an identifier, device fingerprint, and geolocation information. A multimodal violation detection engine combines a classifier for identifying prohibited information. The engine is configured to output a violation category label and a confidence score for each item. The multimodal violation detection engine further combines a classifier for detecting non-compliant non-tensor information and a cross-modal fusion model that jointly compiles information pairs to identify violations where the combination of tensor and non-tensor content constitutes an infraction that neither would alone. A rule engine maps the violation category and confidence score to enforcement tiers. A closed feedback loop logs enforcement decisions and information removals, with appealed decisions overturned by human review being used as corrective training examples for the violation detection engine, enabling adaptation to evolving compliance standards and adversarial evasion techniques. If the cross-modal fusion model outputs a confidence score below a minimum threshold due to out-of-distribution information, enforcement defaults to a conservative rule based solely on the tensor classifier.

In one or more embodiments, the system is applied to a transaction monitoring system. A transaction ingestion module is configured to receive wire transfers, card payments, and account deposits from a core banking system, customer identity data from a know-your-customer database, and external watchlist feeds from regulatory bodies. Each transaction is time-aligned and enriched with payer and payee entity identifiers. A hybrid detection engine is configured to combine a rule-based component encoding regulatory red-flag scenarios and a graph neural network component trained on historical confirmed suspicious activity reports. The rule-based component is configured to detect structuring, rapid movement, and high-risk jurisdiction patterns. The graph system component is configured to detect complex layering patterns, mule account networks, and previously unseen laundering typologies. The engine outputs a suspicious activity probability and a set of risk factors associated with each transaction cluster. Confirmed parabolic stop and reverse outcomes from regulatory feedback and internal investigation outcomes are fed back to retrain the graph system component on a monthly basis. Accounts cleared after investigation generate negative examples that reduce false positive rates over time. When the graph neural networks' confidence drops below a threshold due to insufficient graph data for a new account, the system defaults to rule-based detection alone.

In one or more embodiments, the system is applied to an automated inspection system. A plurality of high-resolution cameras captures top-down, angled, and side-illuminated images of each component passing through an inspection station on a conveyor. Additional measurement channels include a laser profilometer for coplanarity and a thermal camera for hot-spot detection on powered components. Measurements are time-aligned with the same component serial number for consistency. A hybrid defect detection engine is configured to combine a deterministic image-processing pipeline for known defect types with a deep learning anomaly detector. The deterministic pipeline inspects solder joint areas, component presence or absence, and dimensional tolerance against specification limits. The deep learning anomaly detector, trained on a corpus of normal-production graph, generates a per-pixel anomaly score map for each component, flagging regions that deviate from the established normal distribution. The engine may fuse both outputs into a defect classification and a defect severity score. A control subsystem is configured to execute physical ejection and batch intervention. A closed feedback loop ejects components for manual adjudication. Confirmed true defects are logged, while false positives are recorded and used to fine-tune the deep learning anomaly detector on a weekly cycle. The anomaly detector's definition of normal adapts to process drift and new product variants. When the deep learning anomaly detector's confidence falls below a threshold due to a new product variant not represented in the training data, ejection decisions default to deterministic specification-limit rules alone.

In one or more embodiments, the system is applied to a safety monitoring system. Onboard sensors may include at least one of cameras, lidar, radar, and inertial measurement modules, generating a time-synchronized perception data stream. An odometry module may provide vehicle speed and steering angle, while a localization module provides map-relative pose. Modalities are time-aligned to a common vehicle clock. A safety assessment engine is configured to receive the perception data stream and estimate a safety envelope. The engine comprises a physics-based reachability analyzer that computes a safe operating region given current vehicle dynamics and a learned risk predictor trained on near-miss and collision event data, estimating collision probability for the next time step under the current trajectory. The safety envelope estimate is a fused metric representing the minimum time-to-collision across all detected objects. Safety envelope excursions and triggered responses are logged and transmitted to a cloud data pipeline. Logged events are used to retrain the risk predictor on a fleet-wide basis, capturing rare scenarios that no single vehicle would encounter frequently. When the learned risk predictor outputs a confidence below a threshold due to an out-of-distribution scene, the safety envelope defaults to the physics-based reachability analyzer's output alone.

In certain embodiments, inference and training workloads may additionally or alternatively be executed on emerging computational substrates including, but not limited to, neuromorphic processors, spiking neural network accelerators, analog in-memory computing arrays, photonic processors, superconducting logic, and quantum or quantum-assisted compute modules. Workflows may use including but not limited to quantum circuit simulators, hybrid variational algorithms (including but not limited to VQE, QAOA), or cross-compilation frameworks targeting quantum gates or analog-neural primitives. Such systems may interface with AI execution stacks through device bridge layers, kernel offloading frameworks, or accelerator abstraction APIs.

In one or more further implementations, the system is configured to be applied for a mental energy and psychological system. The system functions by obtaining a first intermediate representation (IR) associated with a first computational context related to mental energy or psychological treatment; obtaining a second intermediate representation (IR) associated with a second computational context; generating a common intermediate representation (IR) based on the first IR and the second IR, wherein the common IR is independent of the native data formats of the first and second IRs and can be interpreted by both as control instructions for their respective operational sequences; updating at least one of the first IR or the second IR based on the common IR; wherein the common IR is transmitted to the first and second IRs to trigger corresponding operations between them, and the operations are performed in any order or at least partially concurrently; and each step is configured to associate with a unique identifier. The system further configures coordinated actions among one or more heterogeneous computational modules with multimodal data within a system without direct physical coupling, thereby effecting homomorphic behavioral unification across the heterogeneous computational modules. These modules operate as a physically decoupled yet comparable scaled whole under a central coordination logic, independent operation, and unified management mechanisms. Common interpretation rules are stored in a local memory of each computational module in forms such as lookup tables, finite state machines, emotional entropy scales, narrative value exchange evaluators, emotional entropy ledgers, module economics, and microcode. Upon failing to interpret the common IR, the functional module is configured to enter a safe state and report a failure to the central coordination logic. During an initialization phase, the central coordination logic transmits a set of calibration indicators to the computational modules and establishes, based on responses of the functional units thereto, a baseline mapping between inputs and the common IR. The central coordination logic dynamically adjusts the generation parameters of the common IR based on execution feedback from the functional modules, including at least one of execution latency, execution deviation, or energy consumption, so as to optimize coordination efficiency. The central coordination logic comprises a reinforcement learning module that uses a system-level coordination performance metric as a reward signal to continually train a policy for generating the common IR. The central coordination logic maintains a library of representation tools respectively corresponding to different operating scenarios and is configured to select or combine tools from the library based on real-time scenario identification. For example, in a mental energy and psychological treatment context, if the current state shows low emotional entropy due to a user's negative emotions, the system will adjust its parameters to help the model provide appropriate interventions. The model will continuously adapt based on real-time feedback and future predictions to ensure the user's state improves over time.

Successor deep learning frameworks, model compilers, graph optimizers, and hardware runtimes are deemed equivalents. Including future model-compression, quantization, distillation, LoRA-style adapters, and hardware-aware compilation frameworks. For healthcare or clinical deployments, embodiments may incorporate safety, audit, and compliance mechanisms, including real-time anomaly detection, fail-safe execution modes, traceable decision logging, clinician review pathways, and model governance controls, wherein the output unit restrictions satisfy HIPAA, GDPR, or equivalents.

The embodiments disclosed herein are provided for purposes of illustration and enablement. They shall not be interpreted as limiting the scope of the claims except where explicitly required. Computational components, functional blocks, operations, and architectural arrangements are representative, and the claimed subject matter encompasses structural equivalents, functional replacements, distributed implementations, and computational variations. Features described in relation to a particular embodiment may be combined with features of other embodiments unless technically incompatible. Conversely, features disclosed together may be practiced individually or in sub-component combinations, and the scope of the claims includes such combinations, decompositions, substitutions, and rearrangements.

Execution sequences shown are non-limiting and do not imply any specific order of steps is required; instead, steps may be reorganized, parallelized, omitted, supplemented, or executed concurrently while achieving the intended functionality unless explicitly stated otherwise.

Implementations may include distributed training, federated execution, on-device inference, or heterogeneous acceleration using various hardware and software platforms, including GPUs, TPUs, NPUs, dedicated ML accelerators, trusted execution hardware, or cloud-edge hybrid environments. Parallel processing, model partitioning, pipelined execution, and asynchronous scheduling may be applied to achieve the intended functionality.

The claims shall be construed to cover all implementations supported by the specification, including technological equivalents foreseeable to a person skilled in the art at the filing date, without limitation to any particular embodiment or example described herein.

Software and hardware boundaries described herein are conceptual and do not constrain deployment; instead, processing logic may be consolidated or distributed across networked, virtualized, or hardware-accelerated environments.

Embodiments may incorporate secure enclaves, encrypted computation, differential privacy, secure aggregation, identity assurance, audit logging, and compliance with data-protection frameworks. Security mechanisms may be centralized or distributed and may leverage cryptographic primitives, hardware-rooted trust, or attestation protocols to ensure the integrity of the system.

The disclosure therefore offers a practical and verifiable contribution, while remaining consistent with statutory requirements for patent protection. Together, these embodiments illustrate that the same underlying technology is domain-agnostic and applicable to multiple industries without limitation.

### GLOSSARY

For clarity of exposition, the present application may adopt updated or standardized terminology compared to that used in related provisional applications, within its ecosystem invented by the same applicant, or other disclosures. Unless expressly stated otherwise, different terms referring to substantially the same functionality, structure, or process shall be regarded as interchangeable equivalents. By way of example, the following non-limiting equivalences are intended:

The subject matter described herein may be embodied in whole or in part through digital circuitry, programmable processors, dedicated logic devices, non-transitory computer-readable media bearing executable instructions, or combinations thereof. Non-transitory computer-readable media include, without limitation, semiconductor memory, magnetic and optical storage media, and other persistent storage mechanisms suitable for retaining executable code and associated data.

The terms “engine,” “module,” “unit,” “block” “program,” and analogous expressions refer to code or logic-whether monolithic or distributed-operative to implement the recited functionality. The terms “database” or “data store” refer broadly to any arrangement for retaining data, whether structured or unstructured, and whether centralized or distributed.

The present invention and within its ecosystem describe various combinations of options using specific phrases. Specifically, phrases such as “/,” “and/or”, and “at least one of” are used to denote the selection of individual options or their combination. For instance, when describing a choice between A and B, the phrase “A/B” indicates that either option can be selected individually or both options together. Similarly, the phrase “A and/or B” allows for the selection of either option alone (A or B) or both options together (A and B). Additionally, the phrase “at least one of A and B” encompasses any combination that includes at least one of the options: A, B, or both A and B. Furthermore, the phrase “A, B, and/or C” describes various combinations including selecting A only, B only, C only, A and B, A and C, B and C, or all three options A, B, and C. This principle can be extended to any number of listed items.

In this system and its ecosystem, any symbols such as represents “ [symbol] ,” “x” “v” “y.” “z,” and their variants generally denote data objects, representations, or intermediate results, which may include raw data, processed data, feature vectors, metadata, or any combination thereof. Functions such as “H(⋅),” “F(⋅),” “G(⋅),” and “T(⋅)” generally denote mappings, transformations, or operators between corresponding spaces. For example, a mapping “H:X→V” may be applied to an input “x∈X” to generate a representation “v∈V”, i.e., “v=H(x)”. Such mappings may be configured, parameterized, or instantiated in various manners depending on the application context, and may include, without limitation, encoding functions, feature extraction functions, cryptographic transformations, or other deterministic or non-deterministic processes. The resulting representations may be used for purposes such as verification, identification, indexing, comparison, storage, or further processing. In some implementations, a representation “v” derived from data x may be recorded in a distributed ledger or blockchain system (including but not limited to “on-chain,” “chain-based”), while the corresponding data “x”, or a portion thereof, may be stored off-chain. The recorded representation “v “may serve as an anchor, commitment, or verification reference associated with the data x.” enabling subsequent integrity verification, consistency checking, or data association. Unless otherwise specified, the aforementioned functions may operate on all or part of the input data, and may be applied at different granularities, including elementwise, field-wise, block-wise, or on entire data structures. The specific forms, implementations, and compositions of the functions and representations described herein are not limited to the examples above and may be replaced, combined, or modified without departing from the scope of the present disclosure.

As used herein, the term “data,” “dataset” or “database” refers broadly to any arrangement for storing or retaining data. The data may be structured, semi-structured, or unstructured, and may reside across one or multiple physical or logical storage resources. By way of example, an index store may comprise multiple datasets with distinct organizational formats and access mechanisms.

Framework refers to software/system environments with reusable components/APIs, including but not limited to DL ML (TensorFlow, PyTorch, JAX), data (Spark, Flink, Hadoop), orchestration (Kubernetes, Docker Swarm), and equivalents. It is including but not limited to structural or conceptual structure that provides a foundation, organizational model, or set of guidelines for the development and implementation of systems or processes. Adapter as used herein may encompass what earlier disclosures referred to as a “Framework adapter”, “framework handler” or “framework connector.” A component or module that facilitates the integration and interoperability between different frameworks by providing a common interface or bridge. Although certain embodiments are described as software implementations, the disclosed functionality may alternatively be implemented in dedicated or semi-dedicated hardware circuitry, including currently known or later-developed computing architectures and processing technologies. In certain embodiments, one or more components described herein may be implemented using ASICs, FPGAs, programmable logic, NPUs, custom accelerators, distributed processing systems, or other later-developed hardware architectures.

The disclosed components and processing stages are defined according to their functional relationships rather than any fixed implementation form. Accordingly, individual components may evolve to process richer, multi-modal, hierarchical, latent, or later-developed data representations while remaining within the disclosed architecture. Likewise, intermediate transformation stages, hidden computational layers, routing mechanisms, abstraction layers, or dynamically generated processing operations may exist between disclosed components or method steps without departing from the scope of the present disclosure.

The functions may be any suitable function, including but not limited to a linear transformation, a nonlinear transformation, a polynomial function, a power function, an exponential function, a neural network model, a kernel function, or any combination thereof. In different implementations, different computation techniques may be employed. The mapping function and computation techniques are not limited to the above examples, and may vary without departing from the scope and spirit of the invention.

A computing system, component, or executable instruction set is deemed “configured to” perform a function when arranged, programmed, or otherwise provisioned such that, when in operation, it effectuates the recited functionality. Such configuration may arise through hardware logic, firmware programming, software execution, or any combination thereof. The described processes may be executed by one or more processors under program control, by dedicated logic, or by hybrid arrangements thereof. System elements may be co-located or geographically distributed and may operate in stand-alone fashion or in concert across networked devices.

The term “Metrics,” “Parameters” refers to metrics used for measuring and evaluating the performance of the system. These parameters can take on both quantitative forms (including but not limited to time window size, processing speed) and qualitative forms (including but not limited to environmental sensors, selections, ratings, and rankings). Furthermore, they may be dynamically adjustable based on specific environments, industries, systems, particular strategies, tasks, and other factors. By continuously monitoring these metrics in real-time and making adaptive adjustments, the efficient operation and optimization of the system can be enforced.

The terms “network”, “engine,” “module,” “unit,” “block” “program,” “subunit,” “node,” “submodule,” “system,” “subsystem,” “network,” “subnetwork” and analogous expressions refer to code or logic—whether monolithic or distributed—operative to implement the recited functionality. Module/unit/component/system/node/layer: processors executing stored instructions that realize the specified including but not limited to methods, rules or algorithms; terms are interchangeable. Self-contained parts with specific functions within a larger system, where “module,” “node” and “unit” are general terms for components, “component” refers to a fundamental unit, “subsystem” is a smaller system performing a specific function, and “subunit” is a more granular part of a component. “Layer” can further refine the functionality of these subunits.

“Key” refers to a identifier used for lookup and indexing, while Key-Pattern may refer to specific recurring arrangements or structures within a set of data or events. In fields as statistics, machine learning, and signal processing, patterns are often used to describe the regularity of presentations, such as periodic fluctuations in time series or feature shapes in images. Analysis involving Key Pattern involves identifying these repetitive patterns and extracting information or making predictions from them. Key-Value maybe used for quick positioning and access of data items.

As used in this specification, the terms “develop,” “learn,” “adaptive”, “improve”, “evolve,” “automatic/automatically,” “expansion,” and are hereby defined to describe the process of adjusting operations or values during system training. Specifically, “learn” refers to the acquisition of new knowledge or skills through iterative refinement; “adaptive” indicates the capacity for self-adjustment in response to environmental changes or inputs; “improve” signifies enhancements in performance, efficiency, or accuracy over time resulting from learning and optimization processes; “expansion” refers to the incremental increase in functionality, capacity, or scope through additional training or updates; and “evolve” describes the ongoing development and refinement of system behavior and performance over time.

Similarly, the term “engine” is used to denote software-implemented logic—whether embodied in a single process or distributed across multiple components—configured to execute designated functions. An engine may include one or more modules or services operating on one or more computing devices. In some deployments, a dedicated computing resource may host a particular engine; in others, multiple engines may execute cooperatively or concurrently within shared computational infrastructure.

The collective terms “mechanism”, “method”, “logic”, “workflow”, “rule”, “policy”, “strategy” “approach” and “algorithm” are hereby defined to encompass the processes, procedures, or systems that govern how the system functions. Specifically, “mechanism” pertains to the underlying framework or infrastructure that enables specific operations or functionalities; “method/strategy” refers to a procedure or process for achieving a particular objective, often comprising a combination of steps or actions; “logic” encompasses the principles, reasoning, or decision-making processes governing the system's behavior; “workflow” describes the combinational flow of data, tasks, or procedures within the system; “rule” refers to predefined conditions or constraints dictating how certain operations should be performed or decisions made; and “algorithm” denotes a precise, systematic, and well-defined procedure for solving problems or performing calculations. These mechanisms may be applied in various schemes, including but not limited to rule-based, internal evaluation, probabilistic, learning-based, dynamic multiple weights-based approaches. Furthermore, these terms can be interchanged and expanded to include additional concepts including but not limited to relationships, orders, interactions, sequences, or combinations. Any disclosed connection, operation, or processing transition may include intervening latent stages, abstraction layers, transformation mechanisms, emergent computational structures, or dynamically instantiated processing entities. Accordingly, a component may evolve over time to utilize different data representations, latent structures, multimodal inputs, adaptive architectures, distributed cognition mechanisms, virtualized computation layers, or other presently known or later-developed processing paradigms while remaining within the scope of the corresponding disclosed component. Such evolution in implementation form shall not, by itself, be interpreted as constituting a different architectural component where substantially similar functional objectives, interactions, or system roles are maintained.

“Multi-dimensional” refers to a system's ability to operate across multiple levels, domains, or dimensions, including Spatiotemporal Energy, high-dimensional spaces, parallel dimensionalities, temporal dimensions spanning past, present, and future, energetic dimensions encompassing various forms of energy and their interactions, and spatial dimensions covering diverse physical and virtual realms. This multidimensionality enables the system to integrate complex relationships and patterns, fostering a comprehensive understanding of interconnected phenomena that exist concurrently across multiple planes, realities, timelines, energies, and spaces. This term also implies the capacity to process, analyze, and respond to multiple aspects or facets of a problem or situation, including those with high dimensionality, such as large datasets or complex systems, leading to enhanced insights, decision-making, and overall performance.

In that case, “Spatiotemporal Energy Relationship” refers to the relationships that can be used to analyze data, including but not limited to temporal, energy, spatial, spatiotemporal, temporal-energy, spatial-energy, and spatiotemporal-energy. This flexible and adaptive framework allows for the analysis of relationships and patterns across different scales and domains in various contexts.

“Trust-Based” refers to a framework or mechanism that facilitates collaboration among nodes within a system by enforcing cooperation based on shared goals. This approach ensures that all nodes work together to achieve a common objective, such as maintaining overall efficiency or improving prediction accuracy. By promoting trust among nodes, this framework or mechanism reduces the likelihood of disruption or compromise by other modules, maintains overall system integrity, and enforces fair allocation of resources among sub-modules. Trust-Based system is configured to uses identity-based authentication and other trust indicators to evaluate the credibility of entities or systems within the ecosystem. By establishing trust relationships, the framework or mechanism may facilitate seamless communication, cooperation, and resource allocation, while also enabling effective decision-making and adaptation to change environments.

“Pattern” refers to a recurring arrangement or sequence of elements, structures, or relationships that exist across multiple levels, scales, or domains. This pattern can be observed in various forms, such as Spatiotemporal Energy Relationship arrangements, temporal sequences, or energetic interactions. A pattern implies a degree of regularity, coherence, and predictability, which can be used to inform understanding, make predictions, and guide decision-making. In the context of this patent specification and within the ecosystem, patterns may refer to complex relationships and associations between different variables, systems, or phenomena, which can be used to identify trends, anomalies, or opportunities for optimization. The recognition and analysis of patterns are essential components of many artificial intelligence and machine learning algorithms, allowing them to make informed decisions and adapt to changing environments.

“Dynamic” refers to a system's ability to adapt its behavior or state in response to internal or external conditions. This adaptability enforces flexibility and responsiveness to change environments or requirements, resulting in improved performance, efficiency, and effectiveness. “Dynamically” refers to the process of adjusting or changes to a system, process, or component in response to changing conditions. This involves continuous monitoring and modification to improve optimal performance and effectiveness.

“Balance” refers to a state of equilibrium or stability where different components, elements, or forces are harmonized and maintain a consistent interaction. This concept is crucial in various technical contexts, such as resource allocation, performance metrics, user experience, regulatory compliance, and continuous monitoring. Conditions for achieving dynamic balance resource allocation, Performance Metrics; User Experience, Regulatory Compliance under Real-Time Monitoring, Usage of Resources, Load Balancing, Performance Metrics, Regulatory Compliance with Continuous Monitoring, Feedback Loops, adaptive rules/algorithms/frameworks mechanisms or Review and Interventions.

“Hybrid-Time” method combines real-time processing with historical data analysis to achieve more comprehensive decision-making. This approach can be dynamically switched based on different parameters, including Real-Time Operation, Historical Data Processing, Contextual Dynamic Switching, or Multi-Tenant Environment Applications rates.

“real-time” refers to a processing timeframe that is contemporaneous with the occurrence of the event or data being processed. For instance, when monitoring a patient's vital signs in real-time, the system processes and displays the data as it is received, reducing significant delay or latency. In this sense, “real-time” implies a processing speed and accuracy that are commensurate with the immediacy of the event or information.

“Self-Consistency” refers to a state or a mechanism where an entity or system consistently demonstrates coherence and stability within its own internal dynamics, processes, and behaviors. This self-consistency enables the entity to maintain its integrity, resist external influences that might compromise its internal coherence, and adapt to changing environments while preserving its fundamental nature.

“Self-Developing” refers to a process or system that is capable of generating its own growth, improvement, and evolution through internal mechanisms and dynamics. This self-development may involve learning, adaptation, innovation, and optimization, leading to increased complexity, sophistication, and effectiveness.

“Self-Developing” refers to a process or system that has the ability to learn, adapt, break, restart, and evolve on its own. This self-development enables the system to resolve its own problems, overcome challenges, and extend its capabilities through internal mechanisms and dynamics.

“Self-Resolution” refers to a process or system that has the ability to reorganize, exchange, resolve and recreate itself in response to changing circumstances. This self-resolution enables the system to resolve its own contradictions, paradoxes, and inconsistencies by: transferring or reassigning existing resources; reconfiguring or recombining components; creating new connections or relationships; solving problems or addressing conflicts; converting or transforming itself to adapt to new situations. Self-resolution enables systems to adapt to changing circumstances, reconcile conflicting perspectives, and find harmony within themselves, ultimately leading to greater stability, coherence, and resilience.

“Narrative” refers to a coherent and meaningful group of events, experiences, or ideas that convey a story, message, or understanding. A narrative can be verbal (spoken or written), visual (through images or videos), or even experiential (based on personal experiences). It may involve characters, plot, setting, and theme, which together create a compelling and engaging account of events.

Emotional Entropy refers to a measure that takes into account all entities involved in a system, which can produce energy and contribute to the overall emotional landscape. This entropy value reflects the collective emotional impact or resonance generated by a system's behavior, action, or event. By considering the emotional dynamics between these entities, Emotional Entropy provides insight into the complex interplay of emotions that arises from the interactions within the system.

“Meta-Anchor” refers to an initial value or anchor point that serves as a starting point or reference for further calculation, processing, or decision-making.

“World Model” refers to a conceptual framework for understanding complex systems, processes, and phenomena, providing a shared language, structure, and context for knowledge integration, decision-making, and communication.

“Meta-Core-Engine (Meta-System)” refers to an overarching, abstract, and adaptive framework that orchestrates, integrates, and governs multiple interconnected systems, processes, or modules. A meta-core-engine (meta-system) serves as a high-level manager, coordinating interactions, flows, and decision-making across different levels of abstraction, scales, and domains.

“Applicant-defined” refers to a set of custom elements, methods, parameters, logics, mechanisms, formats, system elements, structures or components that are specifically defined by the applicant. These elements can be tailored according to unique industry needs, events, timeframes, and other factors based on predefined relationships and internal rules of the system. Usage scenarios include but not limited to customization requirements, industry-specific needs, event-based adjustments, timeframe-sensitive, operations or among other. Factors affecting the “Applicant-Defined” mode include but not limited to customized performance, compliance with regulations, improved user experience, enhanced efficiency, flexibility, or Scalability.

“Dynamic Information Processing Unit (DIPU) refers to a processing component or state-calibration module. DIPU is configured to explore, generate, process, and evaluate relationship, key pattern, relevant threshold value and uncertainty, using relationship, key pattern, relevant threshold value and uncertainty as constraints for nodes linking, logical directions and structural superposition to trace the inference chains to align with target intentions of the multimodal input, and maintain versioned inference states for further verification.

“Dynamic Balance Adjustment Unit (DBAU) refers to a monitoring component or context-routing module. DBAU is configured to apply one or more dynamic balance adjustment mechanisms, wherein applying a dynamic balance adjustment mechanism comprises: receiving compliance filtered data and classifying relationship, pattern and information extractions of each of the input features in the input spatiotemporal energy relationship; and using spatiotemporal energy relationship, pattern or information extractions to generate one or more execution graph for each of the input features in the input spatiotemporal energy relationship; computing a combinational value based on the difference between the inferenced output and one or more feedback datasets; determining whether a model-update or reconfiguration condition is satisfied based on a predefined decision point condition, and inputting the feedback data into the system as next round re-input data.

“Security Unit (SU)” refers to a compliance enforced module, interaction component. SU is configured to ensure the security and integrity of sensitive data while preventing unauthorized access. SU is configured to apply one or more compliance mechanisms to each execution and components of the system, wherein applying one or more compliance mechanisms comprise: initialize, audit performance of interaction, parameters, or model-update validation; filter multimodal data to achieve consistency; guide the interaction and triggering a call back, roll back, model update signal when the performance does not satisfy a threshold metric.

“Input and Output” refers to input and output modules. Input and Output are configured to: receive the multimodal input, provide the logical chain of each step for the multimodal input to audit, produce one or more optimal selection and feasible output schemes for the further embedding, and generate an aggregate respective task-specific output of each of the plurality of input features in the input relationship.

“Adaptive Compiler (AC)” refers to a revertible compiler with “SMLS” or “Affection Pinnacle Converter (APC)”. AC is configured to perform cleaning, process data to achieve consistency, determine relationships, patterns, signals, and information extractions of each of the input features, and use relationships, patterns, signals, vectors, and information extractions to generate one or more input intermediate representations and an initial execution graph for each of the input features. In some deployments, all-in-one AC comprises SU, DBAU, DIPU as meta-core engine.

“Spatial Reaction Pattern Module” refers to a shared framework for internal or external components to exchange, explore, test, encrypt, distribute, compress, and store data.

“Spatial Domain Module,” “Spatial Pattern Topological Transformer Module,” and “Temporal Pattern Module” collectively refers to an input-processing-output framework. In certain embodiments, these modules are also referred to as DBAU, DIPU, and SU. In further embodiments, each module may comprise one or more instances of DBAU, DIPU, and SU. Additionally, in other embodiments, the “Spatial Domain Module” may specifically refer to an AC with integrated DBAU, DIPU, and SU components.

Components and elements are configured to associate with identifiers, mutually couple, combine, and form adjustable clusters or operate independently, and are operable with an integrated feedback loop, based on a defined task.

For the purposes of this invention, an “Adapter” refers to a component or module that facilitates the integration and interoperability between different frameworks by providing a common interface or bridge. This concept is often referred to as a “Framework adapter,” “framework handler” or “framework connector” in earlier disclosures. Examples of adapters include but are not limited to: Interoperability bridges, Interface connectors, Framework handlers, Integration modules. These adapters enable seamless communication and data exchange between different frameworks, systems, or components, thereby promoting collaboration, efficiency, and innovation.

“Meta-Language” refers to domain-specific language (DSL) and declarative language (including but not limited to JSON/YAML/XML/custom) compiled into execution plans controlling routing, policies, topology, and thresholds with versioning and rollback. A language used to describe or define other languages, enabling higher-level abstraction and meta-programming.

“Structured Meta-Language System (SMLS)” refers to a unified structured meta-language system component in the meta-system that provides consistent and structured programming methods for different systems to improve compatibility and efficiency. The SMLS comprise one or more sub-units, each containing one or more mechanisms or rules that enable adaptive compilation into an executable representation. Adapters integrate one or more frameworks to facilitate seamless interaction with various components. The Structured Meta-Language/domain-specific language (DSL) defines the rules for converting source code and their mutual transformations but does not directly determine the categorization of specific data attributes or execution paths, nor output judgments.

“Quantum-like” refers to a framework or structure that simulates principles of quantum computing, achieving more efficient and scalable processing through parallelism and superposition techniques without adding the complexity of actual quantum bits (qubits).

A “data processing apparatus” encompasses any machine or collection of machines configured to execute instructions for manipulating data, including general-purpose or special-purpose processors, distributed computing resources, and dedicated logic circuitry such as field-programmable gate arrays (FPGAs) and application-specific integrated circuits (ASICs). A computing environment may further comprise firmware, operating systems, protocol stacks, database systems, or runtime engines that collectively support execution of program logic. User interaction may be facilitated through displays, input peripherals, touch interfaces, audio devices, haptic mechanisms, or network-based interfaces accessible via browsers, mobile applications, or other communication clients. Communications between system components may occur over wired or wireless digital networks including, without limitation, local and wide area networks, and the Internet.

In this system's ecosystem, “transition” may emphasize the “movement” rather than the “transformation” of states. This meta-system is configured to dynamically switch between the two approaches for multi-domain coordination and under dynamic meta-learning model.

“Identity-as-the-Perimeter (IatP)” refers to identity verification becoming the primary or sole boundary control point, where all access attempts rely on identity authentication to determine whether to allow entry into network resources. In one or more embodiments, this framework is used for user authentication and authorization, with a user's identity authenticated to determine whether external requests are allowed to enter local network resources. This framework can be performed parallel in forward, backward, and multidimensional directions. In another application scenario, the meta-system uses IatP to construct a resource allocation infrastructure system, where the system accesses data and allocates resources to different nodes through authentication and authorization.

While specific implementations are described to provide a complete understanding of the invention, it will be understood that the invention is not limited to these forms and can be practiced in various alternative forms and configurations. The scope of the invention is intended to encompass all possible implementations, thereby facilitating its utility and versatility.

Elements or functionalities described in one embodiment can be applied to other embodiments, and features shown together may also be used separately or in sub-combinations in alternative embodiments. The claimed subject matter covers all such variations, including changes in ordering, partitioning, or execution of processes.

Additionally, while certain operations may be described in a specific sequence, this is not a limitation unless explicitly stated. Operations may be performed concurrently, in parallel, or in a different order while still achieving the desired results. Multi-threading, asynchronous processing, and parallel execution are also applicable. The delineation of components, modules, or services is for conceptual purposes; they may be distributed, integrated, or rearranged in other implementations.

The embodiments disclosed herein are provided for illustrative and enforcement purposes only and should not be interpreted as limiting the scope of the claims except where explicitly required. Functional blocks, units, operations, and architectural arrangements are representative, and the claimed subject matter encompasses structural equivalents, functional replacements, distributed implementations, and computational variations. Features described in relation to a particular embodiment may be combined with features from other embodiments unless technically incompatible.

Conversely, features disclosed together may be practiced individually or in sub-component combinations, and the scope of the claims includes such combinations, decompositions, substitutions, and rearrangements.

In specific embodiments, improvements may be directed towards efficiency, model accuracy, latency reduction, privacy, resource management, or distributed execution. While this disclosure provides specific examples and implementations, these are intended for illustration purposes only and should not limit the scope of the claims. The disclosed features may be combined, modified, or rearranged in various ways unless explicitly stated otherwise.

Embodiments may incorporate secure enclaves, encrypted computation, differential privacy, identity assurance, audit logging, and compliance with data-protection frameworks. Security mechanisms may be centralized or distributed and may leverage cryptographic primitives, hardware-rooted trust, or attestation protocols to enforce the integrity of the system.

Execution shown is non-limiting and does not imply any specific order of steps is required; instead, steps may be reorganized, parallelized, omitted, supplemented, or executed concurrently while achieving the intended functionality unless explicitly stated otherwise. Implementations may include distributed training, federated execution, on-device inference, or heterogeneous acceleration using various hardware and software platforms, including GPUs, TPUs, NPUs, dedicated ML accelerators, trusted execution hardware, or cloud-edge hybrid environments. Parallel processing, model partitioning, pipelined execution, and asynchronous scheduling may be applied to achieve the intended functionality. Software and hardware boundaries described herein are conceptual and do not constrain deployment; instead, processing logic may be consolidated or distributed across networked, virtualized, or hardware-accelerated environments.

The disclosure therefore offers a practical and verifiable contribution, while remaining consistent with statutory requirements for patent protection. Together, these embodiments illustrate that the same underlying technology is domain-agnostic and applicable to multiple industries without limitation.

The detailed description that follows provides an architectural and operational context for the disclosed technology. Specific embodiments are presented for purposes of explanation and clarity. However, these examples are non-limiting, and variations, equivalents, and alternative configurations may be employed without departing from the scope of the claimed subject matter. In some implementations or embodiments, the representations, notations, or symbols may be obtained by applying a mapping function to input data.

The claims shall be construed to cover all implementations supported by the specification, including technological equivalents foreseeable to a person skilled in the art at the filing date, without limitation to any particular embodiment or example described herein.

1. A system comprising:
one or more processors; one or more memory modules with instructions stored therein, which when executed by the one or more processors, cause the processors to:
obtaining a first intermediate representation (IR) associated with a first computational context;
obtaining a second intermediate representation (IR) associated with a second;
generating a common intermediate representation (IR) based on the first IR and the second IR;
updating at least one of the first IR or the second IR based on the common IR; and
wherein the common IR is independent of the native data formats of the first and second IR and can be interpreted by both the first and second intermediate representations (IRs) as control instructions for their respective operational sequences;
wherein common IR is transmitted to the first and second IRs to trigger correspondence operations between them;
wherein the operations are performed in any order or at least partially concurrently; and
wherein each of the step configured to associate with a identifier.

2. The system of claim 1, wherein the system further configured to:
coordinate actions among one or more heterogeneous computational modules with multimodal data within a system without direct physical coupling, thereby effecting a homomorphic behavioral unification across the heterogeneous computational modules, causing them to operate as a physically decoupled yet comparable scaled whole, under a central coordination logic, independent operation, and unified management mechanisms;
convert the uploaded data into structured data according to a predefined schema;
encrypt at least a portion of the structured data using a cryptographic algorithm;
record the encrypted structured data on-chain in an immutable manner;
track provenance and lineage of the structured data across the distributed ledger; and
enable submission, query, and verify of the structured data.

3. The system of claim 1, wherein the standardized common IR comprises from at least one of:
emotional entropy representation, spatiotemporal energy relationship representation, timing reference marker, a module identifier, and an operation command code.

4. The system of claim 2, wherein the central coordination logic is configured to: generate the common IR by performing from at least one of emotional entropy exchange, logical operation, emotional entropy principle, state machine transition, lookup table mapping upon the inputs; and
wherein the common IR comprises a priority field designating an order in which the functional modules are to execute their respective operations.

5. The system of claim 4, wherein a first input is in a data object and a second input is in an multi-dimensional or multimodal data format,
wherein the central coordination logic is further configured to unify both into a common IR prior to generating the common IR;
wherein the first input operates in a first clock domain and the second input operates in a second clock domain; and
wherein the central coordination logic comprises a cross-clock-domain synchronizer configured to align the first and second inputs.

6. The system of claim 2, wherein the central coordination logic comprises a protocol adaptation module configured to uniformly parse inputs originating from different bus or network protocols.

7. The system of claim 1, wherein the common IR is simultaneously communicated to all of the functional modules via broadcast, multicast, a publish-subscribe mechanism; and
wherein the common IR is communicated over a dedicated s unified, comparable scaled common bus that is independent of data paths of the functional modules.

8. The system of claim 2, wherein each of the computational module, upon receiving the common IR, is configured to return an acknowledgement signal to the central coordination logic.

9. The system of claim 2, wherein the central coordination logic is configured to encrypt the common IR prior to transmission; and
Wherein each of the computational module comprises a corresponding decryption key.

10. The system of claim 8, wherein each of the computational module comprises a representation parser; and
wherein the representation parser configured to interpret the common IR according to a pre-provisioned common interpretation rule.

11. The system of claim 10, wherein the common interpretation rule is stored in a local memory of each computational module in the form of a lookup table, a finite state machine, an emotional entropy scale, a narrative value exchange evaluator, an emotional entropy ledger, a module economics, microcode;
wherein the functional module, upon failing to interpret the common IR, is configured to enter a safe state and report a failure to the central coordination logic;
wherein the central coordination logic is configured, during an initialization phase, to transmit a set of calibration indicia to the computational modules and to establish, based on responses of the functional units thereto, a baseline mapping between inputs and the common IR;
wherein the central coordination logic is further configured to dynamically adjust a generation parameter of the common IR based on execution feedback from the functional modules, including at least one of execution latency, execution deviation, or energy consumption, so as to optimize coordination efficiency;
wherein the central coordination logic comprises a reinforcement learning module that uses a system-level coordination performance metric as a reward signal to continually train a policy for generating the common IR;
wherein the central coordination logic maintains a library of representation tool respectively corresponding to different operating scenarios, and is configured to select or combine tools from the library based on a real-time scenario identification; and
wherein a library of representation tool comprising emotional entropy scale, narrative transportation, narrative value exchange evaluator, emotional entropy ledger, and module economics.

12. The system of claim 2, further comprising a plurality of computational modules each having a local coordination logic;
wherein the central coordination logic is configured to transmit a system-level common IR to each of the local coordination logic; and
wherein each of the local coordination logic is configured to generate, based on the system-level indicium, a local indicium for the computational module within its respective computational module.

13. The system of claim 2, wherein the central coordination logic is configured to receive an inter-domain common IR from a counterpart central coordination logic of a different domain, and to translate the inter-domain indicium into the standardized common IR interpretable by one or more computational modules of its own domain;
wherein the counterpart central coordination logic is configured to detect joining or leaving of a computational module and to update, in response thereto, a generation policy of the IR and a target module list.

14. The system of claim 2, wherein the common IR comprises a target-pair identifier that instructs the first computational module and the second computational module to establish direct point-to-point alignment therebetween without relaying subsequent alignment signals through the central coordination logic.

15. The system of claim 1, wherein the system is an autonomous driving safety monitoring or control system, and the computational module comprise at least one perception module and at least one actuation module;
wherein the perception module comprises a radar, a sensor or camera, and the actuation module comprises a braking controller or a steering controller;
wherein the computational module further includes a self-adaptation algorithm module that is trained to auditing, governance, risk assessment, prediction, recording structured data on-chain in an immutable manner with a distributed ledger;
wherein the module is configured to be used for predictive analytics in industries such as financial transaction monitoring, life science, robot, aerospace;
wherein the system is deployed as a cloud-based application that can be accessed via multiple devices and is adaptable to different devices and platforms for use in self-adaptative quality detection; and
wherein the coordinated action comprises a joint control of emergency braking and steering.

16. The system of claim 1, wherein the system is an compliance controller, and the coordinated action comprises multi-axis unified motion; and
wherein the system is a multi-core processor, and the computational modules are processing cores, and the common IR coordinates lockstep operation thereof;
wherein at least one computational module or model of the system is implemented in a custom hardware circuit configured to perform its designated tasks;
wherein at least one computational module of the system is implemented in a custom computational module of the system is implemented in a virtualized execution environment, including virtual machines, containers, or cloud-based computational resources;
wherein at least one computational module of the system is implemented in a combination of hardware, software, firmware, and virtualized resources;
wherein at least one computational module of the system is implemented in custom hardware, while others are implemented in virtualized or software-based environments, and the system dynamically manages all modules according to its mechanism;
wherein each of the computational module and model of the system may be implemented in custom hardware circuits, including ASICs, FPGAs, neuromorphic chips, including presently known or later-developed technologies;
wherein each computational module of the system may be implemented in software, firmware, virtual machines, containers, or cloud-based computational resources;
wherein each computational module may be implemented in a combination of hardware, software, firmware, virtualized resources, or future computational technologies; and
wherein the system may be deployed on mobile devices, portable computing platforms, edge computing nodes, including presently known or later-developed technologies.

17. The system of claim 1, wherein the system further comprises a domain-specific language (DSL) meta-language system along with an adaptive compiler;
wherein the DSL meta-language system is configured to define and compile at least one of task graphs, adapter bindings, and resource constraints into one or more executable representation;
wherein the DSL meta-language system is configured to define an abstract IR and a typed operator-and-graph specification of processing blocks, connectors, data types, constraints, budgets, structural configuration, deployment descriptors including container and orchestration manifests;
and
wherein the system's operations are specified by a DSL meta-language system vocabulary secured against tampering; and wherein DSL meta-language system specifications are version-controlled, cryptographically signed, and tamper-evident.

18. The system of claim 12, wherein the plurality of computational module is arranged in one or more proprietary topologies selected from a group consisting of polymorphic topological configurations;
wherein the polymorphic topological configurations comprising quantum-like structured, tree, mesh, directed acyclic graph (DAG), ring, hierarchical layered topology or Applicant-defined topology;
wherein the operator blocks are interconnected according to a configuration comprising a layered structure, and are arranged into input, intermediate, and output layers defined by functional relationships;
wherein the system operations comprise at least one of: rule-based, graph-based, logic-based, learning-based, proprietary hybrid reasoning strategies or Applicant-defined operation;
wherein any attempt to mimic, alter, or substitute said structural arrangements without validated authorization metadata is automatically rejected by the system, thereby preventing unauthorized reproduction of system architecture;
wherein graphical or structural representation elements of modules, including flowcharts, block diagrams, or topology schematics, are operably associated with authorization metadata, and access to derivative reproduction is controlled based on an authorization state derived from the authorization metadata;
wherein a usage attestation includes a model version identifier and license scope, is cryptographically or Applicant-defined encryption method signed, is generated per batch and is bound to the decentralized identifier (DID);
wherein a signature chain is recorded, and the decentralized identifier (DID) is bound to a model version identifier and a state version identifier;
wherein the system is performed across federated nodes, each node validating DID-based authorization before contributing to an aggregated execution plan,
wherein outputting the result includes executing a data-processing pipeline performing validation, feature construction, batch or streaming operations, and employing accelerators;
wherein training or execution is permitted only on datasets cryptographically signed or authorized via decentralized identifier (DID) binding, thereby preventing use of unauthorized or unverified data sources; and
wherein derivative execution, retraining, or structural replication of logic, semantics, or topology is restricted unless authorization metadata is validated.

19. A computer-implemented method comprising:
obtaining a first intermediate representation (IR) associated with a first computational context;
obtaining a second intermediate representation (IR) associated with a second;
generating a common intermediate representation (IR) based on the first IR and the second IR;
updating at least one of the first IR or the second IR based on the common IR; and
wherein the common IR is independent of the native data formats of the first and second IR and can be interpreted by both the first and second intermediate representations (IRs) as control instructions for their respective operational sequences;
wherein common IR is transmitted to the first and second IRs to trigger correspondence operations between them;
wherein the operations are performed in any order or at least partially concurrently; and
wherein each of the step configured to associate with a identifier.

20. A non-transitory computer-readable storage medium storing instructions that, when executed by one or more processors; one or more memory modules with instructions stored therein, which when executed by the one or more processors, cause the processor to:
obtaining a first intermediate representation (IR) associated with a first computational context;
obtaining a second intermediate representation (IR) associated with a second;
generating a common intermediate representation (IR) based on the first IR and the second IR;
updating at least one of the first IR or the second IR based on the common IR; and
wherein the common IR is independent of the native data formats of the first and second IR and can be interpreted by both the first and second intermediate representations (IRs) as control instructions for their respective operational sequences;
wherein common IR is transmitted to the first and second IRs to trigger correspondence operations between them;
wherein the operations are performed in any order or at least partially concurrently; and
wherein each of the step configured to associate with a identifier.
